(19) United States
(12) Patent Application Publication
(10) Pub. No.: US 2017/0330677 A1
(43) Pub. Date: Nov. 16, 2017

(54) SPACE TRANSFORMERS, PLANARIZATION LAYERS FOR SPACE TRANSFORMERS, METHODS OF FABRICATING SPACE TRANSFORMERS, AND METHODS OF PLANARIZING SPACE TRANSFORMERS

(71) Applicant: Cascade Microtech, Inc., Beaverton, OR (US)

(72) Inventors: Jay Salmon, Portland, OR (US); Roy E. Swart, Hillsboro, OR (US); Brandon Liew, Beaverton, OR (US)

(21) Appl. No.: 15/152,177

(22) Filed: May 11, 2016

(51) Int. Cl. H01F 27/28; H01F 41/04

(52) U.S. Cl. CPC H01F 27/2804; H01F 41/041

(57) ABSTRACT

Space transformers, planarization layers for space transformers, methods of fabricating space transformers, and methods of planarizing space transformers are disclosed herein. In one embodiment, the space transformers include a space transformer assembly including a first rigid space transformer layer, a second rigid space transformer layer, and an attachment layer that extends between the first rigid space transformer layer and the second rigid space transformer layer. In another embodiment, the space transformers include a space transformer body and a flex cable assembly. The planarization layer includes an interposer, a resilient dielectric layer, a planarized rigid dielectric layer, a plurality of holes, and an electrically conductive paste extending within the plurality of holes. In one embodiment, the methods include methods of fabricating the space transformer assembly. In another embodiment, the methods include methods of planarizing a space transformer.

### FIELD OF THE DISCLOSURE

The present disclosure relates to space transformers, to planarization layers for space transformers, to methods of fabricating space transformers, and to methods of planarizing space transformers.

### BACKGROUND OF THE DISCLOSURE

Space transformers often are utilized in the electronics industry to adapt, or transform, a plurality of electrical traces from a first relative spacing, or a first pitch, to a second relative spacing, or a second pitch. The first relative spacing may be associated with a first piece of hardware and/or with a first manufacturing technology, and the second relative spacing may be associated with a second piece of hardware and/or with a second manufacturing technology. As an example, an integrated circuit package, which may function as a space transformer, may be utilized to adapt electrical traces that may be present on a printed circuit board (i.e., the first piece of hardware and/or the first manufacturing technology) to electrical traces that may be present on an integrated circuit device (i.e., the second piece of hardware and/or the second manufacturing technology).

As another example, probe systems that are utilized to test the operation of integrated circuit devices may utilize a space transformer to convey electrical signals between a signal generation and analysis assembly of the probe system and a device under test (DUT) that is being tested by the probe system. More specifically, the space transformer may be utilized to adapt from a relative spacing that may be associated with electrical traces and/or contacts that are on a printed circuit board to a relative spacing that may be associated with contact pads on the DUT.

Space transformers are complicated structures that may take many weeks, or even several months, to fabricate. In addition, conventional space transformers are fabricated utilizing a layer-by-layer, or serial, process in which a plurality of layers is built up, one on top of the other, to define the space transformer. Such a serial process results in the long fabrication times that are discussed above. In addition, the individual layers cannot be separately tested prior to assembly of the conventional space transformer. As a result, a defect in any one of the layers, of which there may be a dozen or more, may cause the conventional space transformer to be nonfunctional, adding to the fabrication time and/or cost of the conventional space transformer. Furthermore, conventional space transformers must be custom-fabricated for specific applications. This may result in additional costs and/or delays, especially during development of new products. Thus, there exists a need for improved space transformers, planarization layers for space transformers, methods of fabricating space transformers, and/or methods of planarizing space transformers.

### SUMMARY OF THE DISCLOSURE

Space transformers, planarization layers for space transformers, methods of fabricating space transformers, and methods of planarizing space transformers are disclosed herein. In one embodiment, the space transformers include a space transformer assembly including a first rigid space transformer layer, a second rigid space transformer layer, and an attachment layer that extends between the first rigid space transformer layer and the second rigid space transformer layer. The attachment layer operatively attaches the first rigid space transformer layer to the second rigid space transformer layer and electrically interconnects a plurality of first lower contact pads of the first rigid space transformer layer with a corresponding plurality of second upper contact pads of the second rigid space transformer layer.

In another embodiment, the space transformers include a space transformer body and a flex cable assembly. The space transformer body includes a rigid dielectric body, a plurality of electrically conductive contact pads, a plurality of electrically conductive attachment points, and a plurality of body electrical conductors. The flex cable assembly includes a plurality of ribbon electrical conductors that defines a plurality of cable ribbons. The plurality of cable ribbons defines a layered stack of cable ribbons. A body-proximal conductor end of each of the plurality of ribbon electrical conductors is operatively attached to a corresponding one of the plurality of electrically conductive attachment points.

The planarization layer includes an interposer, a resilient dielectric layer, a planarized rigid dielectric layer, a plurality of holes, and an electrically conductive paste extending within the plurality of holes. The interposer includes a lower interposer surface and plurality of lower interposer contact pads. The resilient dielectric layer extends across the lower interposer surface and the plurality of lower interposer contact pads. The planarized rigid dielectric layer includes a planarized lower surface and extends across the resilient dielectric layer. The holes extend from the planarized lower surface, through the planarized rigid dielectric layer, through the resilient dielectric layer, and to respective ones of the plurality of lower interposer contact pads. The electrically conductive paste extends, within the holes, from the planarized lower surface to the respective ones of the plurality of lower interposer contact pads.

In one embodiment, the methods include methods of fabricating the space transformer assembly. These methods include providing a first rigid space transformer layer, providing a second rigid space transformer layer, and assembling the first rigid space transformer layer and the second rigid space transformer layer to define the space transformer assembly.

In another embodiment, the methods include methods of planarizing a space transformer. These methods include operatively attaching an interposer to the space transformer, applying a resilient dielectric layer to the interposer, and applying a rigid dielectric layer to the resilient dielectric layer. These methods further include planarizing an exposed surface of the rigid dielectric layer to generate a planarized surface, applying an adhesive layer to the planarized surface, and applying a masking layer to the adhesive layer. These methods also include forming a plurality of holes within the masking layer, the adhesive layer, the rigid dielectric layer, and the resilient dielectric layer. These methods further include applying an electrically conductive paste to the plurality of holes to define a plurality of discrete electrical conductors.

### BRIEF DESCRIPTION OF THE DRAWINGS

FIG. 1 is a schematic side view of a space transformer according to the present disclosure.

FIG. 2 is another example of a space transformer assembly according to the present disclosure.

FIG. 3 is a schematic side view of another space transformer according to the present disclosure.

FIG. 4 is a schematic top view of the space transformer of FIG. 3.

FIG. 5 illustrates an alternative space transformer according to the present disclosure.

FIG. 6 illustrates another alternative space transformer according to the present disclosure.

FIG. 7 is a schematic side view of a planarization layer according to the present disclosure.

FIG. 8 is a flowchart depicting methods, according to the present disclosure, of fabricating a space transformer assembly.

FIG. 9 is a schematic view of a portion of a process flow illustrating the method of FIG. 8.

FIG. 10 is a schematic view of another portion of the process flow illustrating the method of FIG. 8.

FIG. 11 is a flowchart depicting methods, according to the present disclosure, of planarizing a space transformer.

FIG. 12 is a schematic view of a portion of a process flow illustrating the method of FIG. 11.

FIG. 13 is a schematic view of another portion of the process flow illustrating the method of FIG. 11.

FIG. 14 is a schematic view of another portion of the process flow illustrating the method of FIG. 11.

FIG. 15 is a schematic view of another portion of the process flow illustrating the method of FIG. 11.

FIG. 16 is a schematic view of another portion of the process flow illustrating the method of FIG. 11.

FIG. 17 is a schematic view of another portion of the process flow illustrating the method of FIG. 11.

FIG. 18 is a schematic view of another portion of the process flow illustrating the method of FIG. 11.

FIG. 19 is a schematic view of another portion of the process flow illustrating the method of FIG. 11.

FIG. 20 is a schematic view of another portion of the process flow illustrating the method of FIG. 11.

FIG. 21 is a schematic view of another portion of the process flow illustrating the method of FIG. 11.

### DETAILED DESCRIPTION AND BEST MODE OF THE DISCLOSURE

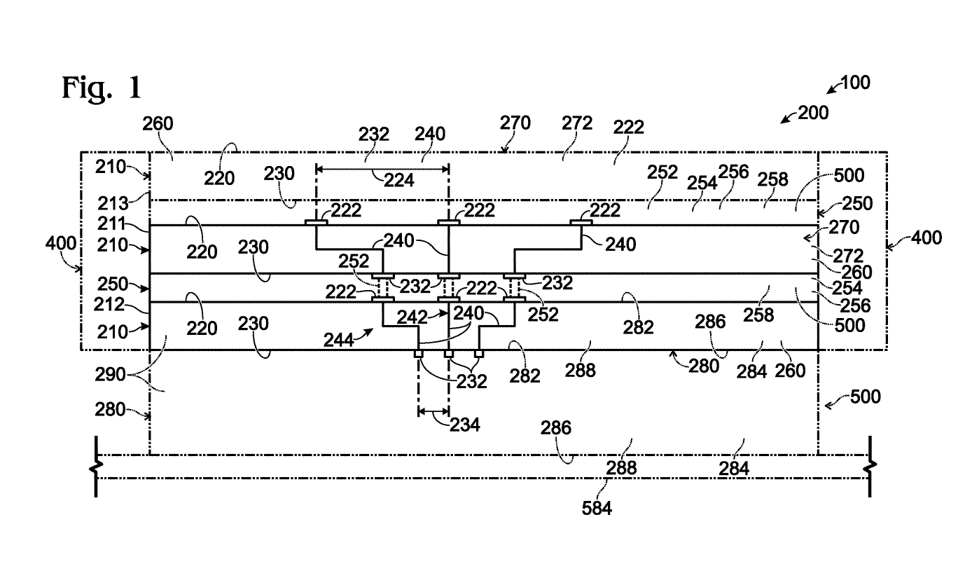

FIGS. 1-21 provide examples of space transformers 100, planarization layers 500, and/or of methods 600/700 according to the present disclosure. Elements that serve a similar, or at least substantially similar, purpose are labeled with like numbers in each of FIGS. 1-21, and these elements may not be discussed in detail herein with reference to each of FIGS. 1-21. Similarly, all elements may not be labeled in each of FIGS. 1-21, but reference numerals associated therewith may be utilized herein for consistency. Elements, components, and/or features that are discussed herein with reference to one or more of FIGS. 1-21 may be included in and/or utilized with any of FIGS. 1-21 without departing from the scope of the present disclosure. In general, elements that are likely to be included in a particular embodiment are illustrated in solid lines, while elements that are optional are illustrated in dash-dot-dot lines. However, elements that are shown in solid lines may not be essential and, in some embodiments, may be omitted without departing from the scope of the present disclosure.

In the present disclosure, several components, structures, and/or features are described utilizing the adjectives “upper” and/or “lower.” These components, structures, and/or features are so described for convenience, and the adjectives “upper” and “lower” do not require, and should not be interpreted to require, a specific relative orientation and/or a specific relative orientation with respect to vertical. As examples, and in practice, an “upper surface” may be above, below, or horizontally opposed to a corresponding “lower surface” without departing from the scope of the present disclosure.

With this in mind, it is within the scope of the present disclosure that any component, structure, and/or feature that is described herein utilizing the adjective “upper” or “lower” additionally or alternatively may be described utilizing one or more alternative adjectives, examples of which include “first,” “second,” “primary,” and/or “secondary.” As an example, an “upper surface” also may be referred to herein as one of a “first surface” and a “second surface.” Similarly, a “lower surface” also may be referred to herein as the other of the “first surface” and the “second surface.” Additionally or alternatively, the adjectives “upper” and “lower” also may be reversed such that an “upper surface” also may be referred to herein as a “lower surface” and a “lower surface” also may be referred to herein as an “upper surface.”

As used herein, the noun “assembly” refers to a collection of sub-structures assembled and/or combined to form a complete structure, or at least a portion of the complete structure (e.g., the assembly). Each of these sub-structures is, by itself, a finished, manufactured product that may be touched, manipulated, and/or tested for relevant properties that will impact the functionality of the assembly in which the sub-structures are utilized. In addition, each of these sub-structures retains a significant portion, or even all, of its original form, shape, and/or function when it is incorporated into the assembly. Stated another way, and as used herein, the noun “assembly” does not refer to a structure that is formed solely by the manipulation of raw materials.

In this context, and as an example, a bicycle may be considered an assembly of a plurality of sub-structures, such as a crank, wheels, tires, a seat, and the like, with these sub-structures being operatively attached to one another to form the bicycle. Each of these sub-structures has a shape, form, and/or function that remains essentially unchanged upon incorporation into the bicycle. In addition, each of these sub-structures may be touched, manipulated, and/or tested for relevant properties (such as dimensions, mechanical strength, and the like) prior to being incorporated into the bicycle.

As another example, a metal bicycle frame also may be considered an assembly of a plurality of metal tubes, which may be welded, brazed, and/or otherwise operatively attached to one another to define the metal bicycle frame. Each of these metal tubes may be considered a sub-structure that has a shape, form, and/or function that remains essentially unchanged when incorporated into the metal bicycle frame. In addition, each of these metal tubes may be touched, manipulated, and/or tested for relevant properties (such as dimensions, mechanical strength, and the like) prior to being incorporated into the bicycle.

In contrast, the tire of the bicycle may not be considered an assembly of the rubber and/or fibers that comprise the tire, since the shape, form, and function of both the rubber and the fibers materially changes upon being incorporated into the tire. Instead, the tire may be considered a sub-structure that is formed from one or more raw, or precursor, materials. Similarly, the metal tubes that form the bicycle frame may not be considered to be assemblies of the metal that comprises the metal tubes since the shape, form, and function of this metal materially changes upon being incorporated into the metal tubes.

FIG. 1 is a schematic side view of a space transformer 100 according to the present disclosure. Space transformer 100 of FIG. 1 also may be referred to herein as a space transformer assembly 200 and includes a plurality of rigid space transformer layers 210. Each rigid space transformer layer 210 is operatively attached to at least one adjacent rigid space transformer layer 210 by a corresponding attachment layer 250, which also electrically interconnects each rigid space transformer layer to the at least one adjacent rigid space transformer layer. As discussed in more detail herein, rigid space transformer layers 210 may be sub-structures, or subassemblies, of space transformer assembly 200. Stated another way, rigid space transformer layers 210 may be finished, manufactured products, or components, that may be operatively attached to another, via one or more attachment layers 250, to generate and/or define the space transformer assembly. Stated yet another way, these rigid space transformer layers may be separately manufactured and subsequently combined, via attachment layers 250, to generate the space transformer assembly. Such a construction is in contrast to conventional space transformers, which generally are a layer-by-layer construction of various raw material components.

Space transformer assemblies 200 according to the present disclosure may provide several benefits over conventional space transformers. As an example, and since each rigid space transformer layer 210 is a separate and/or distinct sub-structure, subassembly, and/or finished, manufactured product, a plurality of such rigid space transformer layers may be manufactured in parallel and subsequently combined to generate space transformer assemblies 200. As another example, a plurality of rigid space transformer layers 210 may be fabricated, in advance, to define a library of rigid space transformer layers from which individual rigid space transformer layers 210 may be selected, based upon one or more selection criteria, and combined to generate space transformer assemblies 200. Such manufacturing processes may provide significant cost and/or time savings over conventional space transformer manufacturing techniques.

As yet another example, a material of construction and/or a fabrication process for one rigid space transformer layer may differ from that of another rigid space transformer layer. This may permit construction of a space transformer assembly that includes some rigid space transformer layers that are configured, or even optimized, for one criterion, such as signal speed, with other rigid space transformer layers that are configured, or even optimized, for another criterion, such as current-carrying capacity.

With continued reference to FIG. 1, rigid space transformer layers 210 may include a planar layer upper surface 220, a planar layer lower surface 230, a plurality of upper contact pads 222, and a plurality of lower contact pads 232. Planar layer lower surface 230 may be opposed, or at least substantially opposed, to planar layer upper surface 220. Upper contact pads 222 may be on, may be present on, may be positioned on, and/or may extend on planar layer upper surface 220. Similarly, lower contact pads 232 may be on, may be present on, may be positioned on, and/or may extend on planar layer lower surface 230.

Rigid space transformer layers 210 further may include a plurality of electrical conductors 240. Each electrical conductor 240 may extend between a respective upper contact pad 222 and a corresponding lower contact pad 232 and/or may be oriented to conduct a respective electric current between the respective upper contact pad and the corresponding lower contact pad. Stated another way, the plurality of electrical conductors of each rigid space transformer layer 210 may be oriented to conduct a plurality of electric currents between the plurality of upper contact pads and the plurality of lower contact pads of each rigid space transformer layer 210.

In the example of FIG. 1, space transformer assembly 200 includes two rigid space transformer layers 210, which are illustrated in solid lines, and one optional and/or additional space transformer layer 210, which is illustrated in dash-dot-dot lines. In this embodiment, rigid space transformer layers 210 include an upper space transformer layer 211 and a lower space transformer layer 212 and also may include an additional space transformer layer 213.

It is within the scope of the present disclosure that upper space transformer layer 211 also may be referred to herein as a first rigid space transformer layer 211. Under these conditions, planar layer upper surface 220 of the first rigid space transformer layer also may be referred to herein as a planar first layer upper surface, and planar layer lower surface 230 of the first rigid space transformer layer also may be referred to herein as a planar first layer lower surface. In addition, upper contact pads 222 of the first rigid space transformer layer also may be referred to herein as first upper contact pads, lower contact pads 232 of the first rigid space transformer layer also may be referred to herein as first lower contact pads, and electrical conductors 240 of the first rigid space transformer layer also may be referred to herein as first electrical conductors.

Similarly, lower space transformer layer 212 also may be referred to herein as a second rigid space transformer layer 212. Under these conditions, planar layer upper surface 220 of the second rigid space transformer layer also may be referred to herein as a planar second layer upper surface, and planar layer lower surface 230 of the second rigid space transformer layer also may be referred to herein as a planar second layer lower surface. In addition, upper contact pads 222 of the second rigid space transformer layer also may be referred to herein as second upper contact pads, lower contact pads 232 of the second rigid space transformer layer also may be referred to herein as second lower contact pads, and electrical conductors 240 of the second rigid space transformer layer also may be referred to herein as second electrical conductors.

While FIG. 1 illustrates 2, or 3, rigid space transformer layers 210, it is within the scope of the present disclosure that space transformer assembly 200 may include any suitable number of rigid space transformer layers. As examples, the space transformer assembly may include at least 2, at least 4, at least 6, at least 8, at least 10, at least 12, at least 14, at least 16, at least 18, at least 20, at least 25, and/or at least 30 rigid space transformer layers 210. Additionally or alternatively, the space transformer assembly may include at most 200, at most 175, at most 150, at most 125, at most 100, at most 90, at most 80, at most 70, at most 60, at most 50, at most 40, at most 30, and/or at most 20 rigid space transformer layers 210.

When space transformer assembly 200 includes more than 2 rigid space transformer layers 210, a rigid space transformer layer may extend between first rigid space transformer layer 211 and second rigid space transformer layer 212 and may be referred to herein as an intermediate rigid space transformer layer. Additionally or alternatively, a rigid space transformer layer may be operatively attached to the first planar layer upper surface of first rigid space transformer layer 211 and may be referred to herein as an upper rigid space transformer layer, and/or a rigid space transformer layer may be operatively attached to the second planar layer lower surface of second rigid space transformer layer 212 and may be referred to herein as a lower rigid space transformer layer.

The following discussion describes space transformer assembly 200 as including first rigid space transformer layer 211 and second rigid space transformer layer 212 that are oriented as illustrated in FIG. 1. However, and as discussed, it is within the scope of the present disclosure that space transformer assemblies 200 may include any suitable number of rigid space transformer layers 200 with any suitable relative orientation therebetween.

Attachment layer 250 may include any suitable structure that may extend between adjacent rigid space transformer layers, such as between first rigid space transformer layer 211 and second rigid space transformer layer 212, that may operatively attach the adjacent rigid space transformer layers, and/or that may electrically interconnect corresponding contact pads of the adjacent rigid space transformer layers. As an example, the attachment layer may electrically interconnect each of the plurality of first lower contact pads of first rigid space transformer layer 211 with a corresponding one of the plurality of second upper contact pads of second rigid space transformer layer 212.

Attachment layer 250 may include, or be, an electrically conductive attachment layer. As an example, attachment layer 250 may include a plurality of discrete, separate, distinct, and/or spaced-apart electrical conductors 252, and a corresponding electrical conductor 252 may extend between corresponding contact pads of the adjacent rigid space transformer layers. Electrical conductors 252 may be positioned to extend only between the corresponding contact pads. Electrical conductors 252 may be formed from any suitable material, examples of which include a metal, a sintered metal, metal solder, an electrically conductive epoxy, a liquid metal, a thermal sonic bond, and/or a sintered copper paste.

Another example of attachment layer 250 may include an anisotropically conductive film 258. The anisotropically conductive film may be configured to conduct an electric current in one direction, such as in a direction that is perpendicular to planar layer upper surfaces 220 and/or to planar layer lower surfaces 230, and to resist conduction of the electric current in a direction that is parallel to the planar layer upper surface and/or to the planar layer lower surface.

As yet another example, attachment layer 250 may include a dielectric attachment material 254, which may extend between the adjacent rigid space transformer layers. The dielectric attachment material may electrically insulate, or isolate, portions of the adjacent rigid space transformer layers from one another and/or may operatively attach, or adhere, the adjacent rigid space transformer layers to one another.

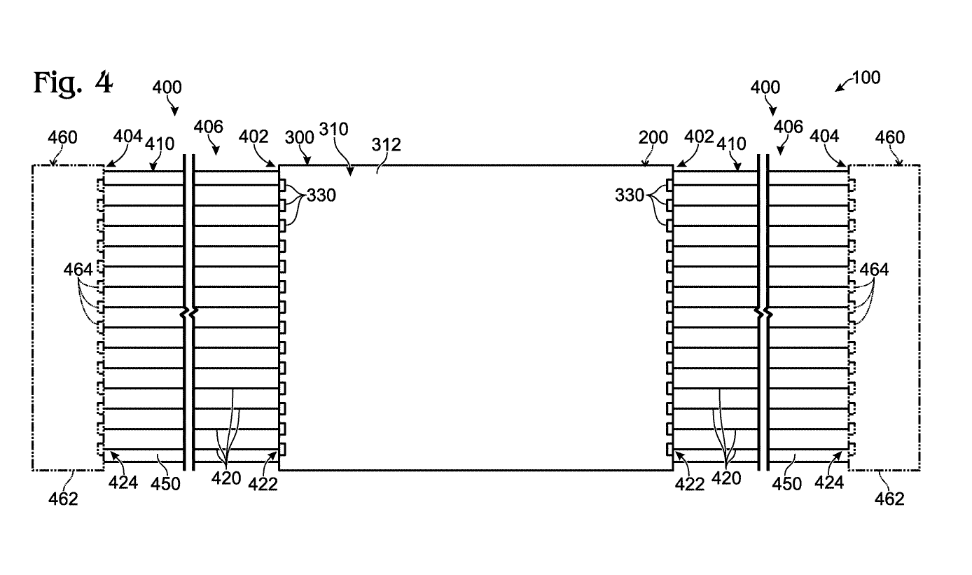

As another example, attachment layer 250 may include, or be, a planarization layer 500. Examples of planarization layer 500 are discussed in more detail herein with reference to FIGS. 4 and 8-18. As illustrated in FIG. 1, planarization layer 500 may be operatively attached to planar layer lower surface 230 of rigid space transformer layers 210 and/or to planar layer upper surface 220 of rigid space transformer layers 210. Additionally or alternatively, planarization layer 500 may extend between adjacent rigid space transformer layers 210 and/or may extend between space transformer assembly 200 and a membrane structure 584, which is discussed in more detail herein.

It is within the scope of the present disclosure that attachment layer 250 may extend directly between the adjacent rigid space transformer layers 210 (e.g., between first rigid space transformer layer 211 and second rigid space transformer layer 212). Stated another way, a given attachment layer 250 may extend in direct contact, in direct physical contact, and/or in direct electrical contact with at least a portion, or even all, of planar layer upper surface 220 of a given rigid space transformer layer 210 (e.g., the second planar upper surface of second rigid space transformer layer 212) and also with at least a portion, or even all, of planar layer lower surface 230 of the adjacent rigid space transformer layer (e.g., the first planar lower surface of first rigid space transformer layer 211). This may include extending across an entirety of a space that is defined between the adjacent rigid space transformer layers or selectively extending between specific portion(s) of the space that is defined between the adjacent rigid space transformer layers. When the attachment layer selectively extends between specific portion(s) of the space that is defined between the adjacent rigid space transformer layers, an air gap 256 also may extend between at least a portion of the adjacent rigid space transformer layers, such as between a given planar layer upper surface 220 and a corresponding planar layer lower surface 230.

First rigid space transformer layer 211 and second rigid space transformer layer 212 may be adapted, configured, designed, and/or constructed to convey any suitable electric current, electric voltage, and/or electric signal therethrough. As an example, each electrical conductor 240 of first rigid space transformer layer 211 and/or of second rigid space transformer layer 212 may be configured to convey a corresponding power signal, such as a direct current power signal and/or an alternating current power signal, therethrough. The power signal may have a magnitude of at least 0.001 amps, at least 0.01 amps, at least 0.1 amps, at least 0.5 amps, at least 1 amp, at least 5 amps, at least 10 amps, at least 25 amps, at least 50 amps, at least 75 amps, and/or at least 100 amps.

As another example, each electrical conductor 240 of first rigid space transformer layer 211 and/or of second rigid space transformer layer 212 may be configured to convey a corresponding data signal, such as a direct current data signal and/or an alternating current data signal, therethrough. The data signal may include, or be, a high frequency data signal and/or a radio frequency, or RF, data signal. As examples, the data signal may have a frequency of at least 1 kilohertz, at least 10 kilohertz, at least 100 kilohertz, at least 1 megahertz, at least 10 megahertz, at least 100 megahertz, at least 1 gigahertz, at least 10 gigahertz, or at least 100 gigahertz.

As illustrated in FIG. 1, the first layer upper surface of first rigid space transformer layer 211 may be parallel, or at least substantially parallel, to the first layer lower surface of the first rigid space transformer layer, to the second layer upper surface of second rigid space transformer layer 212, and/or to the second layer lower surface of the second rigid space transformer layer. Similarly, the second layer upper surface of second rigid space transformer layer 212 may be parallel, or at least substantially parallel, to the first layer upper surface of first rigid space transformer layer 211, to the first layer lower surface of the first rigid space transformer layer, and/or to the second layer lower surface of the second rigid space transformer layer.

As also illustrated in FIG. 1, the first upper contact pads of first rigid space transformer layer 211 may project from the first layer upper surface thereof. Additionally or alternatively, the first lower contact pads of first rigid space transformer layer 211 may project from the first layer lower surface thereof. Similarly, the second upper contact pads of second rigid space transformer layer 212 may project from the second layer upper surface thereof. Additionally or alternatively, the second lower contact pads of second rigid space transformer layer 212 may project from the second layer lower surface thereof. However, this is not required, and one or more contact pads may not project from the corresponding surfaces, as illustrated in FIG. 4.

As further illustrated in FIG. 1, a location, or a layout, of each of the first lower contact pads of first rigid space transformer layer 211 may correspond to, or be a mirror image of, a location, or a layout, of each of the second upper contact pads of second rigid space transformer layer 212. Stated another way, and when first rigid space transformer layer 211 and second rigid space transformer layer 212 are assembled into space transformer assembly 200, each of the plurality of first lower contact pads of first rigid space transformer layer 211 may be opposed to, directly opposed to, or facing toward, a corresponding one of the plurality of second upper contact pads of second rigid space transformer layer 212.

Upper contact pads 222, including the first upper contact pads and/or the second upper contact pads, may include any suitable material and/or materials of construction. As examples, upper contact pads 222 may include, or be, metallic upper contact pads. Similarly, lower contact pads 232, including the first lower contact pads and/or the second lower contact pads, also may include any suitable material and/or materials of construction. As examples, lower contact pads 232 may include, or be, metallic lower contact pads.

Electrical conductors 240 may include any suitable structure and may extend between corresponding upper contact pads 222 and lower contact pads 232 of a given rigid space transformer layer 210 in any suitable manner. As examples, electrical conductors 240 may include, or be, an electrically conductive via that extends perpendicular, or at least substantially perpendicular, to planar layer upper surface 220 and/or planar layer lower surface 230, as indicated in FIG. 1 at 242. Under these conditions, the electrical conduit also may be referred to herein as extending between corresponding via contact pads of the rigid space transformer layer. Additionally or alternatively, electrical conductors 240 also may include, or be, an electrically conductive trace that extends parallel, or at least substantially parallel, to planar layer upper surface 220 and/or to planar layer lower surface 230, as indicated in FIG. 1 at 244. Under these conditions, the electrical conduit also may be referred to herein as extending between corresponding trace contact pads of the rigid space transformer layer.

Electrical conductors 240 may include and/or be formed from any suitable material and/or materials. As an example, electrical conductors 240 may include, or be, metallic electrical conductors.

Similarly, rigid space transformer layers 210 may include and/or be formed from any suitable structure, material, and/or materials. As examples, rigid space transformer layers 210, including first rigid space transformer layer 211 and/or second rigid space transformer layer 212 may include one or more of a printed circuit board and a high density interconnect layer. As another example, rigid space transformer layers 210, including first rigid space transformer layer 211 and/or second rigid space transformer layer 212 may include a respective dielectric body 260 that may define planar layer upper surface 220 and/or planar layer lower surface 230 thereof.

As discussed herein, space transformers 100, including space transformer assemblies 200 of FIG. 1, may be configured to adapt, change, or transform, an average pitch, or spacing, of electrical signals that may be conveyed therethrough. Thus, and as illustrated in FIG. 1, an average pitch, or spacing, 234 of the second lower contact pads of second rigid space transformer layer 212 may be less than a threshold fraction of an average pitch, or spacing, 224 of the first upper contact pads of first rigid space transformer layer 211. Stated another way, an average distance between each of the second lower contact pads and a closest other of the second lower contact pads may be less than the threshold fraction of an average distance between each of the first upper contact pads and a closest other of the first upper contact pads. FIG. 1 illustrates a space transformer 100 in which the average pitch, or spacing, decreases from top-to-bottom; however, this specific configuration is not required. As an example, the average pitch, or spacing, may decrease from bottom-to-top without departing from the scope of the present disclosure.

The threshold fraction of the average pitch, or of the average distance, may have any suitable value. As examples, the threshold fraction may be at least 1%, at least 5%, at least 10%, at least 20%, or at least 25% of the average pitch, or spacing, of the plurality of first upper contact pads. Additionally or alternatively, the threshold fraction may be at most 400%, at most 300%, at most 200%, at most 100%, at most 50%, at most 40%, at most 30%, at most 20%, at most 10%, at most 5%, at most 1%, or at most 0.1% of the average pitch, or spacing, of the plurality of first upper contact pads.

As illustrated in dash-dot-dot lines in FIG. 1, first rigid space transformer layer 211 and/or another rigid space transformer layer 210 that is operatively attached to first rigid space transformer layer 211 may include, or be, a modular capacitor bank 270. Modular capacitor bank 270, when present, may include a plurality of capacitors 272, such as a plurality of surface mount capacitors and/or a plurality of thin film capacitors. At least a portion, or subset, of capacitors 272 may extend from corresponding planar layer upper surface 220 of modular capacitor bank 270, such as when capacitors 272 include the surface mount capacitors. Each capacitor 272 may be in electrical communication with a corresponding pair of the plurality of electrical conductors 240 and/or may be configured to store electrical power and provide the stored electrical power to one or more components of, or that is in electrical communication with, space transformer assembly 100.

As also illustrated in dash-dot-dot lines in FIG. 1, space transformer assembly 200 further may include a flexible membrane layer 280. Flexible membrane layer 280, when present, may be operatively attached to a rigid space transformer layer 210 of space transformer assembly 200. As an example, the flexible membrane layer may be operatively attached to the second layer lower surface of second rigid space transformer layer 212. Additionally or alternatively, flexible membrane layer 280 may replace, or take the place of, first rigid space transformer layer 211 and/or second rigid space transformer layer 212 within space transformer assemblies 200. Flexible membrane layer 280 also may be referred to herein as, or may be, a membrane space transformer 280 and/or a membrane-based space transformer 280.

Flexible membrane layer 280 may include a membrane upper surface 282, a plurality of membrane upper contact pads 284 on the membrane upper surface, a membrane lower surface 286, a plurality of membrane lower contact pads 288 on the membrane lower surface, and a plurality of membrane electrical conductors 290. In the example of FIG. 1, membrane upper surface 282 faces toward the second layer lower surface of second rigid space transformer layer 212, and membrane lower surface 286 is opposed to membrane upper surface 282. Membrane electrical conductors 290 may be oriented, within flexible membrane layer 280, to conduct a plurality of electric currents between membrane upper contact pads 284 and membrane lower contact pads 288.

Flexible membrane layer 280 may be utilized to change and/or adapt a relative orientation of the contact pads on space transformer assembly 200 to a target, or desired, relative orientation. Stated another way, flexible membrane layer 280 may be configured to per nit customization of the layout of the second layer lower contact pads of second rigid space transformer layer 212. As such, a relative orientation of membrane upper contact pads 284 may correspond to a relative orientation of the second layer lower contact pads of second rigid space transformer layer 212. In addition, a relative orientation of membrane lower contact pads 288 may be selected to have, or to adapt the space transformer assembly to have, the desired relative orientation.

Flexible membrane layer 280 may be operatively attached to a remainder of space transformer assembly 200 in any suitable manner. As an example, the flexible membrane layer may be adhered to a rigid space transformer layer 210, such as second space transformer layer 212, of the space transformer assembly. As another example, the flexible membrane layer may be operatively attached via and/or utilizing a sintered metal paste.

In general, rigid space transformer layers 210 may be stiffer, or more rigid, than membrane layer 280. The difference in the rigidity of rigid space transformer layers 210 when compared to the rigidity of membrane layer 280 may be quantified in any suitable manner. As an example, a stiffness of the membrane layer may be less than a threshold fraction of a stiffness of the rigid space transformer layer. Examples of the threshold fraction include threshold fractions of less than 80%, less than 70%, less than 60%, less than 50%, less than 40%, less than 30%, less than 20%, and/or less than 10% of the stiffness of the rigid space transformer layer.

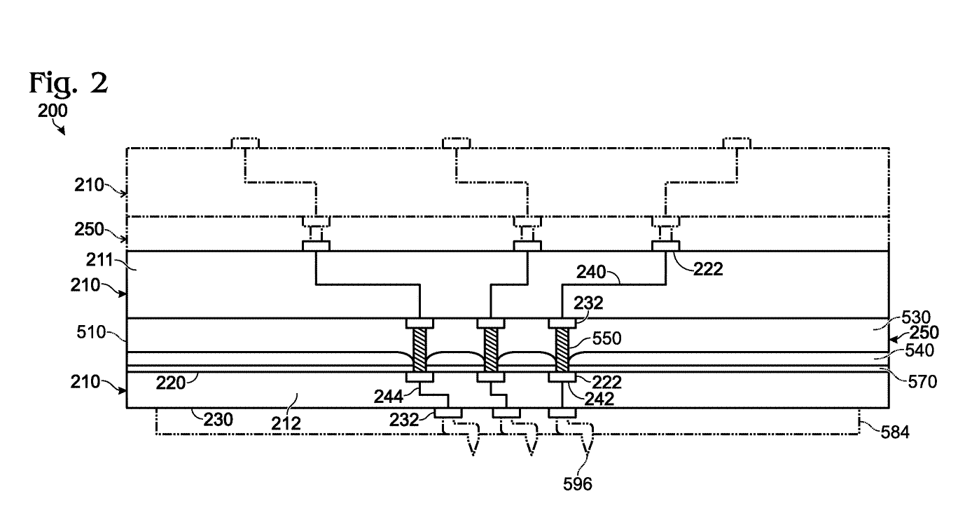

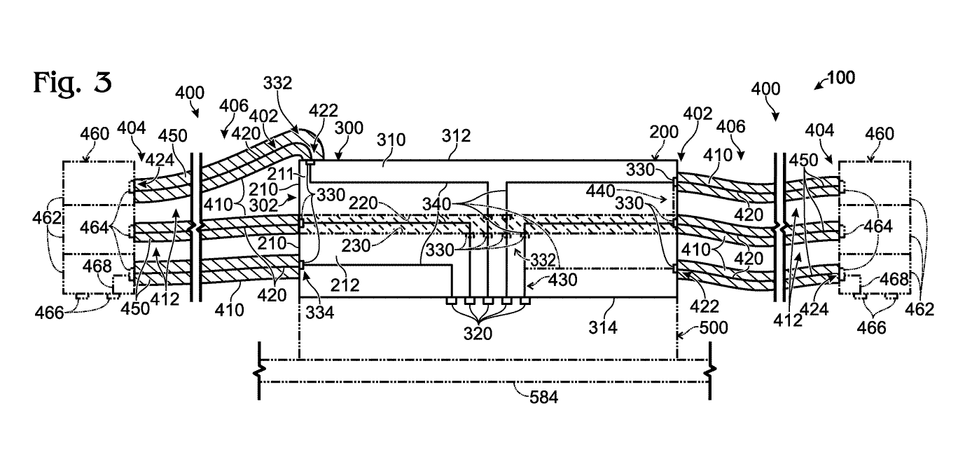

FIG. 1 also illustrates, in dash-dot-dot lines, that space transformer assembly 200 further may include a flex cable assembly 400. Flex cable assembly 400 is illustrated in more detail in FIGS. 2-3 and discussed herein with reference thereto.

FIG. 2 is another example of a space transformer assembly 200 according to the present disclosure. Space transformer assembly 200 of FIG. 2 includes a plurality of rigid space transformer layers 210 and an attachment layer 250 extending between adjacent rigid space transformer layers 210. Rigid space transformer layers 210 and attachment layer(s) 250 may be at least substantially similar, or even identical, to the corresponding structures of FIG. 1. As an example, attachment layer(s) 250 may include, or be, planarization layer(s) 500 and may include a resilient dielectric layer 530, a planarized rigid dielectric layer 540, and an adhesive layer 570, as discussed in more detail herein with reference to FIGS. 4 and 8-18. FIG. 2 illustrates that space transformer assembly 200 may have a membrane structure 584, such as a membrane contacting assembly and/or a membrane space transformer, attached, or directly attached, to a planar lower surface 230 thereof.

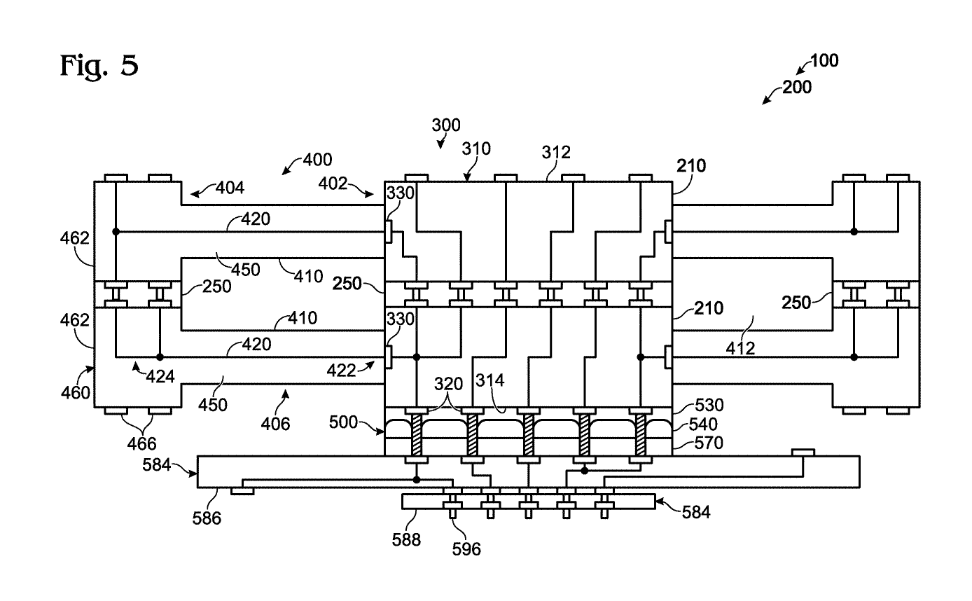

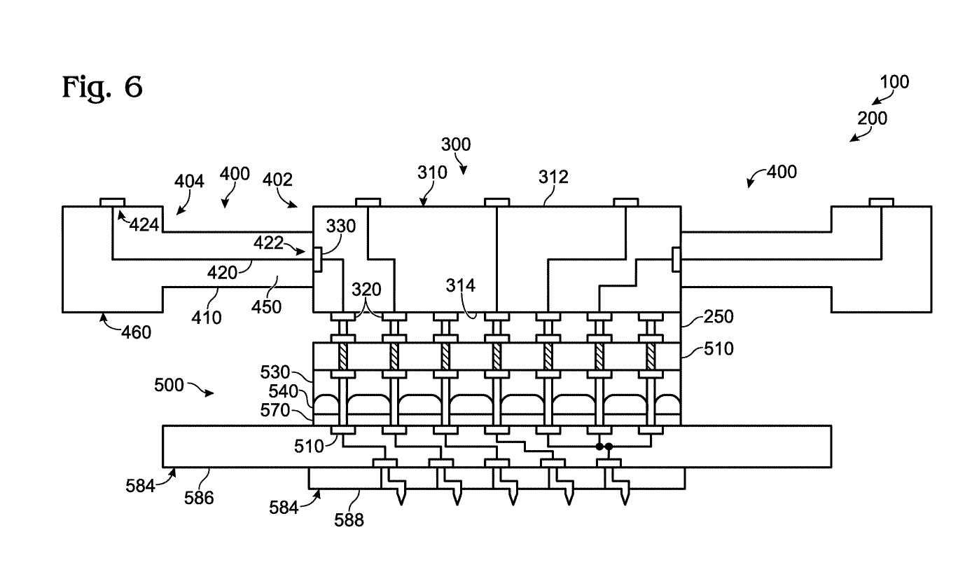

FIG. 3 is a schematic side view of another space transformer 100 according to the present disclosure, while FIG. 4 is a schematic top view of the space transformer of FIG. 3, and FIGS. 5-6 illustrate additional and/or alternative space transformers 100. Space transformer 100 of FIGS. 3-6 includes a space transformer body 300. The space transformer body 300 includes a rigid dielectric body 310 that includes an upper surface 312 and an opposed planar lower surface 314. Space transformer body 300 also includes a plurality of electrically conductive contact pads 320, which are on planar lower surface 314, and a plurality of electrically conductive attachment points 330, which are supported by the rigid dielectric body.

Space transformer 100 of FIGS. 3-6 also includes at least one flex cable assembly 400. Flex cable assembly 400 may include a body-proximal cable end 402 and a body-distal cable end 404, and body-proximal cable end 402 may be proximal to space transformer body 300 relative to body-distal cable end 404.

Each flex cable assembly 400 includes a plurality of ribbon electrical conductors 420. Each ribbon electrical conductor includes a body-proximal conductor end 422, which is operatively attached to a corresponding one of the plurality of electrically conductive attachment points 330, and a body-distal conductor end 424, which may be distal from space transformer body 300 relative to the body-proximal conductor end.

Ribbon electrical conductors 420 define a plurality of cable ribbons 410, with each cable ribbon 410 including a corresponding subset of the plurality of ribbon electrical conductors 420. The cable ribbons 410 of a given flex cable assembly 400 together define a layered stack 406 of cable ribbons 410. As illustrated in solid lines in FIG. 3, cable ribbons 410 may be operatively attached to an edge 302 of space transformer body 300. Under these conditions, electrically conductive attachment points 330 may be located on edge 302. Additionally or alternatively, and as illustrated in dashed lines in FIG. 3, cable ribbons 410 may extend between adjacent rigid space transformer layers 210 of space transformer body 300. Under these conditions, electrically conductive attachment points 330 may be located on a planar layer upper surface 220 and/or on a planar layer lower surface 230 of the rigid space transformer layer.

Space transformers 100, according to the present disclosure, that include flex cable assemblies 400 may be configured such that flex cable assembly 400 provides a threshold displacement, or at least the threshold displacement, of body-proximal cable end 402 relative to body-distal cable end 404 for a given force applied to space transformer body 300. Stated another way, flex cable assemblies 400 may be configured to flex to provide at least the threshold displacement upon application of the given applied force to the space transformer body. The body-distal end of the flex cable assembly may be fixed, or at least substantially fixed, in space, and the threshold displacement may be a measure of motion of the space transformer body relative to the body-distal end of the flex cable assembly.

The threshold displacement may have any suitable value. As examples, the threshold displacement may be at least 1 millimeter (mm), at least 2 mm, at least 4 mm, at least 5 mm, at least 10 mm, at least 15 mm, at least 20 mm, at least 25 mm, and/or at least 30 mm. Additionally or alternatively, the threshold displacement may be at most 50 mm, at most 40 mm, at most 30 mm, at most 25 mm, and/or at most 20 mm.

The threshold displacement also may be described as a fraction of a length of flex cable assembly 400. As examples, the threshold displacement may be at least 5%, at least 10%, at least 15%, at least 20%, and/or at least 25% of the length of the flex cable assembly. Additionally or alternatively, the threshold displacement may be at most 50%, at most 40%, at most 30%, at most 25%, at most 20%, and/or at most 15% of the length of the flex cable assembly.

Similarly, the given force may have any suitable value, or magnitude. As examples, the given force may be at least 1 Newton (N), at least 2 N, at least 3 N, at least 4 N, at least 5 N, at least 6 N, at least 8 N, and/or at least 10 N. Additionally or alternatively, the given force may be at most 1000 N, at most 900 N, at most 800 N, at most 700 N, at most 600 N, at most 500 N, at most 400 N, at most 300 N, at most 200 N, at most 100 N, at most 50 N, at most 20 N, at most 18 N, at most 16 N, at most 14 N, at most 12 N, at most 10 N, at most 8 N, at most 6 N, and/or at most 4 N.

It is also within the scope of the present disclosure that flex cable assemblies 400 disclosed herein do not, or are not required to, flex and/or permit displacement of the space transformer body relative to the body-distal end of the flex cable assembly. Stated another way, the threshold displacement may be 0 mm, or negligible. Under these conditions, flex cable assemblies 400 also may be referred to herein as a rigid, or at least substantially rigid, cable assembly 400.

Flex cable assemblies 400, according to the present disclosure, may be configured to carry, transfer, and/or convey at least a threshold electric current magnitude between body-proximal cable end 402 and body-distal cable end 404 thereof. This threshold electric current magnitude may be conveyed by ribbon electrical conductors 420 of cable ribbons 410 and may be a sum, or total, of the current that may be conveyed by all, or a combination of, the ribbon electrical conductors. Examples of the threshold electric current magnitude include threshold electric current magnitudes of at least 1 milliAmp (mA), at least 50 mA, at least 100 mA, at least 500 mA, at least 1 Amp (A), at least 25 A, at least 50 A, at least 100 A, at least 200 A, at least 300 A, at least 400 A, at least 500 A, at least 600 A, at least 700 A, at least 800 A, at least 900 A, at least 1000 A, and/or at least 1500 A. Additionally or alternatively, the threshold electric current magnitude may be at most 2500 A, at most 2000 A, at most 1800 A, at most 1600 A, at most 1400 A, at most 1200 A, at most 1000 A, and/or at most 800 A.

It is within the scope of the present disclosure that space transformers 100 of FIGS. 3-6 that include flex cable assemblies 400 may be configured such that two, or more, ribbon electrical conductors 420 are electrically shorted together within space transformer body 300.

This may include electrically shorting the two ribbon electrical conductors such that the two ribbon electrical conductors are in electrical communication with a single electrical conductive contact pad 320. Such a configuration may permit the two, or more, ribbon electrical conductors to provide a larger electric current to the single electrically conductive contact pad than otherwise could be provided by a single ribbon electrical conductor.

As an example, and as illustrated in FIG. 3 at 440, the body-proximal conductor end of the two, or more, ribbon electrical conductors 420 may be operatively attached to a single electrically conductive attachment point 330. As another example, and as illustrated in FIG. 3 at 430, a body electrical conductor 340 may electrically interconnect two electrically conductive attachment points 330 with a given, or a single, electrically conductive contact pads 320.

When space transformer 100 includes two, or more, ribbon electrical conductors that are electrically shorted together within space transformer body 300, the two, or more, ribbon electrical conductors may extend within any suitable cable ribbon 410. As an example, the two, or more, ribbon electrical conductors may extend within the same cable ribbon 410. As another example, the two, or more, ribbon electrical conductors may extend within different cable ribbons 410. As yet another example, the two, or more, ribbon electrical conductors may extend within different flex cable assemblies 400.

Flex cable assemblies 400 may include any suitable structure that may include cable ribbons 410 and ribbon electrical conductors 420. In addition, and as discussed, cable ribbons 410 may form layered stack 406 of cable ribbons and may be spaced-apart from one another. Such a configuration may provide greater flexibility in flex cable assemblies 400, according to the present disclosure, when compared to a space transformer that does not include the flex cable assembly of FIGS. 3-6. As examples, layered stack 406 may permit the above-described threshold displacement between space transformer body 300 and body-distal cable end 404 for the above-described applied force on the space transformer body.

As illustrated in FIGS. 3 and 5, a respective air gap 412 may extend between each cable ribbon 410 and an adjacent cable ribbon 410 within layered stack 406. Air gap 412 may extend along at least a threshold portion of the length of the flex cable assembly, which may be measured between body-proximal cable end 402 and body-distal cable end 404. The threshold portion of the length of the flex cable assembly may include at least 50%, at least 60%, at least 70%, at least 80%, at least 90%, at least 95%, and/or at least 99% of the length of the flex cable assembly.

Stated another way, at least an intermediate portion of each cable ribbon 410 in a given flex cable assembly 400 may be separate from, distinct from, and/or spaced-apart from an intermediate portion of each other cable ribbon 410 in the given flex cable assembly 400. The intermediate portion may extend between the body-proximal end and the body-distal end of the flex cable assembly. However, this is not required, and it is within the scope of the present disclosure that flex cable assemblies 400 disclosed herein may not include air gap 412, such as when adjacent cable ribbons 410 contact, or are operatively attached to, one another.

As illustrated in FIGS. 3-6, each cable ribbon 410 further may include a respective ribbon insulator 450. Ribbon insulators 450 may surround ribbon electrical conductors 420 of a given cable ribbon 410, may operatively attach the ribbon electrical conductors of the given cable ribbon to one another (as illustrated in FIG. 4), and/or may electrically isolate each ribbon electrical conductor of the flex cable assembly from each other ribbon electrical conductor of the flex cable assembly. This may include electrically isolating each ribbon electrical conductor from other ribbon electrical conductors that extend within the same cable ribbon 410, as illustrated in FIG. 4, and/or from ribbon electrical conductors that extend within adjacent or other, cable ribbons 410, as illustrated in FIG. 3.

Ribbon insulators 450 may be formed from and/or may include any suitable material and/or materials. As examples, ribbon insulators 450 may include one or more of a dielectric material, a flexible material, and a polymeric material.

As illustrated in dash-dot-dot lines in FIGS. 3-4 and in solid lines in FIGS. 5-6, flex cable assemblies 400 further may include a rigid interface structure 460. Rigid interface structure 460 may be operatively attached to body electrical conductors 420, may be operatively attached to body-distal conductor end 424 of the body electrical conductors, and/or may define body-distal cable end 404 of flex cable assembly 400.

It is within the scope of the present disclosure that rigid interface structure 460 may include a plurality of rigid interface structure layers 462. As perhaps best illustrated in FIGS. 3 and 5, rigid interface structured layers 462 may be stacked and/or operatively attached to one another to define rigid interface structure 460, such as via and/or utilizing one or more attachment layers 250.

Returning more generally to FIGS. 3-5, when the rigid interface structure includes rigid interface structure layers 462, a given rigid interface structure layer may be operatively attached to a corresponding one of the plurality of cable ribbons. As an example, a given rigid interface structure layer 462 may include a plurality of electrically conductive interface structure attachment points 464. Each electrically conductive interface structure attachment point 464 may form a corresponding electrical connection with body-distal conductor end 424 of a corresponding ribbon electrical conductor 420.

Rigid interface structure layers 462, when present, may include any suitable structure. As examples, one or more rigid interface structure layers 462 of rigid interface structure 400 may include and/or be formed from a printed circuit board and/or a high density interconnect layer.

As illustrated in FIGS. 3 and 5, rigid interface structures 460 further may include a plurality of interface structure contact pads 466. Each interface structure contact pad 466 may be in electrical communication with a corresponding ribbon electrical conductor 420 via a corresponding electrically conductive interface structure attachment point 464 and/or via a corresponding interface structure electrical conductor 468, which may extend between the interface structure contact pad and the corresponding electrically conductive interface structure attachment point.

Space transformer body 300 may include, or be, any suitable structure that includes rigid dielectric body 310, electrically conductive contact pads 320, electrically conductive attachment points 330, and body electrical conductors 340. As an example, space transformer body 300 may include, or be, a conventional space transformer, examples of which are discussed herein. As another example, space transformer body 300 may include, or be, a space transformer assembly 200 as disclosed herein with reference to FIGS. 1-3 and 8-10.

When space transformer body 300 includes space transformer assembly 200, a first subset of the plurality of electrically conductive attachment points 330 may be defined by a first rigid space transformer layer 211 and a second subset of the plurality of electrically conductive attachment points 330 may be defined by a second rigid space transformer layer 212, as illustrated in FIG. 3.

Rigid dielectric body 310 may include, or be formed from, any suitable material and/or materials. As an example, the rigid dielectric body may be formed from an electrically insulating material, a plastic, a fiberglass, and/or a ceramic. As another example, the rigid dielectric body may be formed from a plurality of stacked space transformer layers, such as rigid space transformer layers 210 of FIGS. 1-3 and 8-10.

Electrically conductive contact pads 320 may include, or be formed from, any suitable material and/or materials. As an example, electrically conductive contact pads 320 may include a metal and/or may be metallic contact pads. As illustrated in FIG. 3, electrically conductive contact pads 320 may extend, or project, from lower surface 314 of space transformer body 300. However, this is not required, and one or more of the electrically conductive contact pads may be flush with, coplanar with, and/or recessed within lower surface 314 without departing from the scope of the present disclosure.

Electrically conductive attachment points 330 may include, or be formed from, any suitable material and/or materials. As an example, electrically conductive attachment points 330 may include a metal and/or may be metallic attachment points.

In addition, electrically conductive attachment points 330 may be formed, defined, and/or oriented on any suitable portion of space transformer body 300. As an example, one or more electrically conductive attachment points may extend on, or from, upper surface 312 of space transformer body 300, as indicated in FIG. 3 at 332. As another example, one or more electrically conductive attachment points may extend on, or from, edge 302 of space transformer body 300, as indicated in FIG. 3 at 334, and it is within the scope of the present disclosure that all of the electrically conductive attachment points may extend on, or from, an edge 302 and/or that none of the electrically conductive attachment points may be on upper surface 312. Edge 302 may extend between upper surface 312 and lower surface 314, as illustrated.

Body electrical conductors 340 may include, or be formed from, any suitable material and/or materials. As an example, body electrical conductors 340 may include a metal and/or may be metallic electrical conductors. It is within the scope of the present disclosure that at least a portion of at least a first subset of the plurality of body electrical conductors 340 may extend within rigid dielectric body 300 and in a direction that is parallel, or at least substantially parallel, to lower surface 314. Additionally or alternatively, at least a portion of at least a second subset of the plurality of body electrical conductors may extend within rigid dielectric body 300 and in a direction that is perpendicular, or at least substantially perpendicular, to the lower surface.

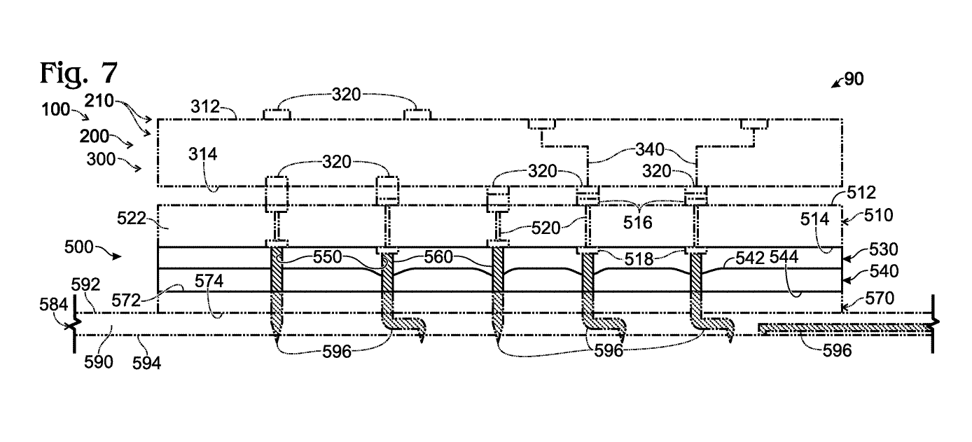

Similar to layered space transformer assembly 200 of FIGS. 1-2 and 8-10, space transformers 100 including flex cable assemblies 400 that are illustrated in FIGS. 3-6 further may include and/or incorporate one or more additional structures, functions, and/or features disclosed herein. As an example, and as discussed, space transformer body 300 may include, or be, space transformer assembly 200 of FIGS. 1-2 and 8-10. As another example, and as illustrated in dash-dot-dot lines in FIG. 3 and in solid lines in FIGS. 5-6, the space transformer of FIGS. 3-6 further may include a planarization layer 500, examples of which are illustrated in FIGS. 7 and 11-21 and discussed herein with reference thereto.

Turning to FIG. 5, space transformer 100 includes a space transformer body 300 that is defined by a space transformer assembly 200. The space transformer of FIG. 5 also includes a plurality of flex cable assemblies 400. In the space transformer of FIG. 5, individual rigid space transformer layers 210 of space transformer assembly 200 may be operatively attached to one another via attachment layers 250. In addition, a planarization layer 500 may operatively attach a membrane structure 584, in the form of a membrane space transformer 586, to lower surface 314 of space transformer body 300. Another membrane structure 584, in the form of a membrane contacting assembly 588, may be operatively attached to membrane space transformer 586. In this configuration, a plurality of signals may be conveyed to and/or from membrane contacting assembly 588 via both membrane space transformer 586 and space transformer body 300.

Turing to FIG. 6, space transformer 100 includes space transformer body 300 and flex cable assemblies 400. An attachment layer 250 operatively attaches a planarization layer 500 to a lower surface 314 of the space transformer body. A first membrane structure 584, in the form of a membrane space transformer 586, is operatively attached to the planarization layer. A second membrane structure 584, in the form of a membrane contacting assembly 588, is operatively attached to the membrane space transformer. Similar to the configuration of FIG. 5, a plurality of signals may be conveyed to and/or from membrane contacting assembly 588 via both membrane space transformer 586 and space transformer body 300.

FIG. 7 is a schematic side view of a planarization layer 500 according to the present disclosure. Planarization layer 500 may be operatively attached to a space transformer 100, such as to space transformer assembly 200 of FIGS. 1-3, 5, and 8-21 and/or to space transformer body 300 of FIGS. 3-4, and may be utilized to planarize a surface of the space transformer and/or to permit the space transformer to be operatively attached to a membrane structure 584. Planarization layer 500 may include an interposer 510 and includes a resilient dielectric layer 530 and a planarized rigid dielectric layer 540. Planarization layer 500 further includes and/or defines a plurality of holes 550 and includes an electrically conductive paste 560 that extends within the plurality of holes. Membrane structure 584 may include a membrane contacting structure 588 and/or a membrane space transformer 586.

Interposer 510, when present, includes an upper interposer surface 512 and an opposed lower interposer surface 514. Interposer 510 also includes a plurality of upper interposer contact pads 516 on upper interposer surface 512 and a plurality of lower interposer contact pads 518 on lower interposer surface 514. Interposer 510 further includes a plurality of interposer electrical conductors 520 extending between the plurality of upper interposer contact pads and the plurality of lower interposer contact pads. Interposer 510 also may include an interposer substrate 522, which may define upper interposer surface 512, may define lower interposer surface 514, may support upper interposer contact pads 516, may support lower interposer contact pads 518, and/or may support interposer electrical conductors 520.

Interposer 510 may include any suitable structure. As an example, interposer 510 may include, or be, a printed circuit board, or PCB. When interposer 510 includes the PCB, interposer substrate 522 may include, or be, a polymeric substrate. As another example, interposer substrate 522 may include, or be, a silicon substrate. When the interposer substrate is the silicon substrate, the plurality of interposer electrical conductors, the plurality of upper interposer contact pads, and/or the plurality of lower interposer contact pads also may be referred to herein as, may be, and/or may be formed by, a plurality of through silicon vias. As yet another example, interposer substrate 522 may include, or be, a ceramic interposer.

As illustrated in FIG. 7, each of the plurality of upper interposer contact pads 516 may be opposed to, or directly opposed to, a corresponding one of the plurality of lower interposer contact pads 518. As such, each of the plurality of interposer electrical conductors may extend perpendicular, or at least substantially perpendicular, to upper interposer surface 512 and/or to lower interposer surface 514.

As also illustrated in FIG. 7, upper interposer surface 512 may be parallel, or at least substantially parallel, to lower interposer surface 514. In addition, upper interposer surface 512 may be a planar, or at least substantially planar, upper interposer surface. Similarly, lower interposer surface 514 may be a planar, or at least substantially planar, lower interposer surface.

Upper interposer contact pads 516 may project, or extend, from the upper interposer surface. Similarly, lower interposer contact pads 518 may project, or extend, from the lower interposer surface. However, this is not required, and upper interposer contact pads 516 and/or lower interposer contact pads 518 may be flush with and/or may be recessed within the corresponding surface of the interposer without departing from the scope of the present disclosure.

As illustrated in FIG. 7, resilient dielectric layer 530 may extend conformally over and/or across a surface and a plurality of contact pads, such as lower interposer surface 514 and lower interposer contact pads 518, when present. Additionally or alternatively, resilient dielectric layer 530 may extend conformally over and/or across lower surface 314 of space transformer body 300 and electrically conductive contact pads 320 that may be present thereon. In addition, resilient dielectric layer 530 may include and/or be formed from any suitable material and/or materials. As examples, resilient dielectric layer 530 may include one or more of a resilient material, a resilient dielectric adhesive, and/or a polymeric material.

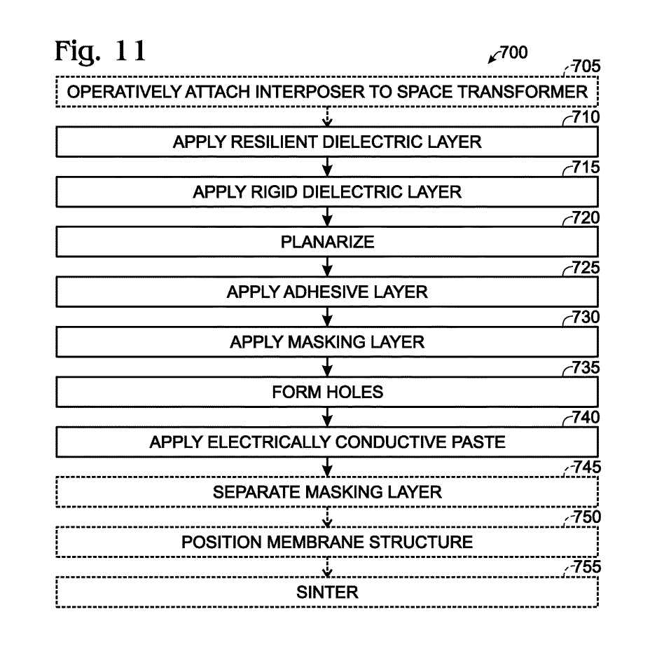

In general, resilient dielectric layer 530 is resilient during formation and/or fabrication of planarization layer 500, as such a configuration may facilitate planarization of planarized rigid dielectric layer 540, which is discussed in more detail herein with reference to methods 700 of FIG. 11. However, resilient dielectric layer 530 may not be, or is not required to be, resilient subsequent to planarization of the planarized rigid dielectric layer and/or during use of the planarization layer. With this in mind, resilient dielectric layer 530 also may be referred to herein as a first dielectric layer 530. Under these conditions, rigid dielectric layer 540 also may be referred to herein as a second dielectric layer 540.

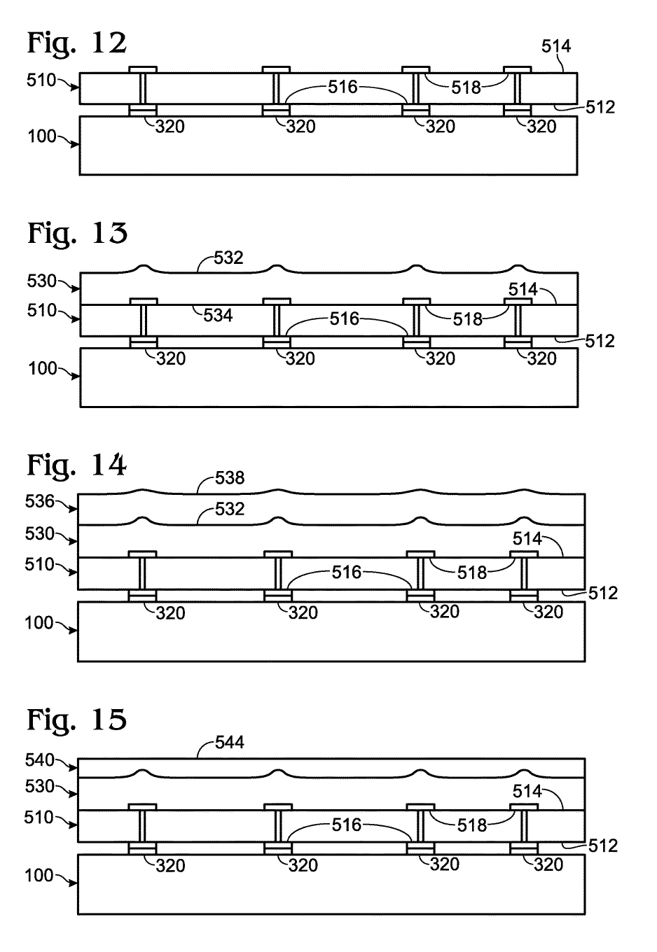

Planarized rigid dielectric layer 540 may include an upper surface 542 and a planarized lower surface 544. Upper surface 542 may extend across and/or may be conformal with resilient dielectric layer 530. As such, upper surface 542 may be nonplanar. In contrast, planarized lower surface 544 may be planar, or at least substantially planar. As an example, planarized lower surface 544 may be planarized during fabrication of planarization layer 500, such as via and/or utilizing methods 700 of FIG. 11 and/or the process flow of FIGS. 12-21, which are discussed in more detail herein. As another example, planarized lower surface 544 may deviate from being planar by a threshold height variation. Examples of the threshold height variation include threshold height variations of at most 40 micrometers, at most 30 micrometers, at most 20 micrometers, at most 15 micrometers, at most 10 micrometers, at most 8 micrometers, at most 6 micrometers, and/or at most 4 micrometers. This threshold height variation may be quite small relative to the height variation of the rigid dielectric layer prior to planarization thereof, which may be on the order of several hundred micrometers.

As discussed, planarization layer 500 may include both resilient dielectric layer 530 and rigid dielectric layer 540. In general, rigid dielectric layer 540 may be stiffer, or more rigid, than resilient dielectric layer 530, and this difference in the rigidity of planarized rigid dielectric layer 540 when compared to resilient dielectric layer 530 may play a significant role in the planarization of, or may permit planarization of, planarized lower surface 544. The difference in the rigidity of planarized rigid dielectric layer 540 when compared to the rigidity of resilient dielectric layer 530 may be quantified in any suitable manner. As an example, a stiffness of the resilient dielectric layer may be less than a threshold fraction of a stiffness of the planarized rigid dielectric layer. Examples of the threshold fraction include threshold fractions of less than 80%, less than 70%, less than 60%, less than 50%, less than 40%, less than 30%, less than 20%, and/or less than 10% of the stiffness of the planarized rigid dielectric layer.

Holes 550 may extend from planarized lower surface 544 of planarized rigid dielectric layer 540. In addition, holes 550 may extend through planarized rigid dielectric layer 540 and/or through resilient dielectric layer 530. Each hole 550 further may extend into contact with a respective one of the plurality of lower interposer contact pads 518 of interposer 510, when present, and/or into contact with a respective electrically conductive contact pad 320 of space transformer body 300. Stated another way, each hole 550 may be at least partially defined, or terminated, by the respective one of the plurality of lower interposer contact pads and/or by the respective one of the electrically conductive contact pads.

Electrically conductive paste 560 may extend within each of the plurality of holes 550. As an example, electrically conductive paste 560 may extend within each hole 550 from planarized lower surface 544 of planarized rigid dielectric layer 540 and to, or into contact with, the respective one of the plurality of lower interposer contact pads 518 of interposer 510, when present, and/or into contact with a respective electrically conductive contact pad 320 of space transformer body 300. As illustrated in FIG. 7, electrically conductive paste 560 may extend only within, or may be confined only to, holes 550.

Electrically conductive paste 560 may include any suitable material and/or materials. As examples, electrically conductive paste 560 may include, or be, an electrically conductive metal paste, an electrically conductive metal alloy paste, an electrically conductive copper paste, and/or an electrically conductive copper alloy paste.

Planarization layer 500 may be included in, or may form a portion of, a planarized space transforming structure 90. Planarized space transforming structure 90 further may include space transformer 100, and the space transformer may include an upper space transformer surface 312, which also may be referred to herein as an upper surface 312, and an opposed planar lower space transformer surface 314, which also may be referred to herein as a lower surface 314.

Space transformer 100 also includes a plurality of electrically conductive contact pads 320, which also may be referred to herein as space transformer contact pads 320. A portion of the plurality of electrically conductive contact pads may be present on planar lower space transformer surface 314 and also may be referred to herein as a plurality of lower space transformer contact pads. In addition, a portion of the plurality of electrically conductive contact pads may be present on upper surface 312 and also may be referred to herein as upper space transformer contact pads. As discussed in more detail herein with reference to space transformer assembly 200 of FIGS. 1-3, 5 and 8-11, an average pitch, or spacing, of the plurality of lower space transformer contact pads may be less than an average pitch, or spacing, of the plurality of upper space transformer contact pads.

Space transformer 100 further may include a plurality of body electrical conductors 340, which also may be referred to herein as space transformer electrical conductors 340. Each space transformer electrical conductor may extend between a given one of the plurality of upper space transformer contact pads and a corresponding one of the plurality of lower space transformer contact pads.

Planarization layer 500 may be operatively attached to lower space transformer surface 314 and/or to space transformer contact pads 320 that extend thereon. This operative attachment may include operative attachment such that each of the plurality of upper interposer contact pads 516, when present, is in electrical communication with a corresponding one of the plurality of space transformer contact pads 320, as illustrated.

Space transformer contact pads 320 may project from lower surface 314, and planarization layer 500 may be utilized to generate a planar surface (e.g., planarized lower surface 544 of planarized rigid dielectric layer 540), which subsequently may be attached to one or more additional structures, as discussed in more detail herein.

As illustrated in FIG. 7, planarized space transforming structure 90 further may include an adhesive layer 570. Adhesive layer 570 may extend across planarized lower surface 544 of planarized rigid dielectric layer 540.

When planarized space transforming structure 90 includes adhesive layer 570, holes 550 may extend through the adhesive layer. As an example, adhesive layer 570 may include an upper adhesive layer surface 572 and an opposed lower adhesive layer surface 574. Upper adhesive layer surface 572 may be in contact with, or adhered to, planarized lower surface 544 of planarized rigid dielectric layer 540, and holes 550 may extend between upper adhesive layer surface 572 and lower adhesive layer surface 574. In addition, electrically conductive paste 560 may extend, within each of the plurality of holes 550, from lower adhesive layer surface 574 and to the respective one of the plurality of lower interposer contact pads 518. In some embodiments, electrically conductive paste 560 further may project from holes 550 and/or past lower adhesive layer surface 574; however, this is not required of all embodiments.

Adhesive layer 570 may include any suitable material and/or materials of construction. As examples, adhesive layer 570 may include one or more of a dielectric adhesive layer, an electrically insulating adhesive layer, and a polymeric adhesive layer.

FIG. 4 also illustrates that planarized space transforming structure 90 further may include membrane structure 584. Membrane structure 584 may include a dielectric membrane 590 that defines an upper membrane surface 592 and an opposed lower membrane surface 594. Membrane structure 584 further may include a plurality of membrane conductors 596. Membrane conductors 596 may extend between upper membrane surface 592 and lower membrane surface 594. Additionally or alternatively, membrane conductors 596 may extend along the membrane structure.

Membrane structure 584 may be adhered to planarized lower surface 544 of planarized rigid dielectric layer 540 by adhesive layer 570. In addition, electrically conductive paste 560 may define a plurality of planarization layer conductors. Each planarization layer conductor may extend between a given lower interposer contact pad 518 and a corresponding one of the plurality of membrane conductors 596, thereby electrically interconnecting the given lower interposer contact pad and the corresponding one of the plurality of membrane conductors.

When planarized space transforming structure 90 includes adhesive layer 570 and membrane structure 584, electrically conductive paste 560, or the plurality of planarization layer conductors that may be defined thereby, instead may be a sintered electrically conductive paste, a sintered metal, and/or a sintered metal alloy. As an example, and as discussed in more detail herein with reference to FIGS. 11-21, the electrically conductive paste may be sintered to produce and/or generate the sintered electrically conductive paste, the sintered metal, and/or the sintered metal alloy.

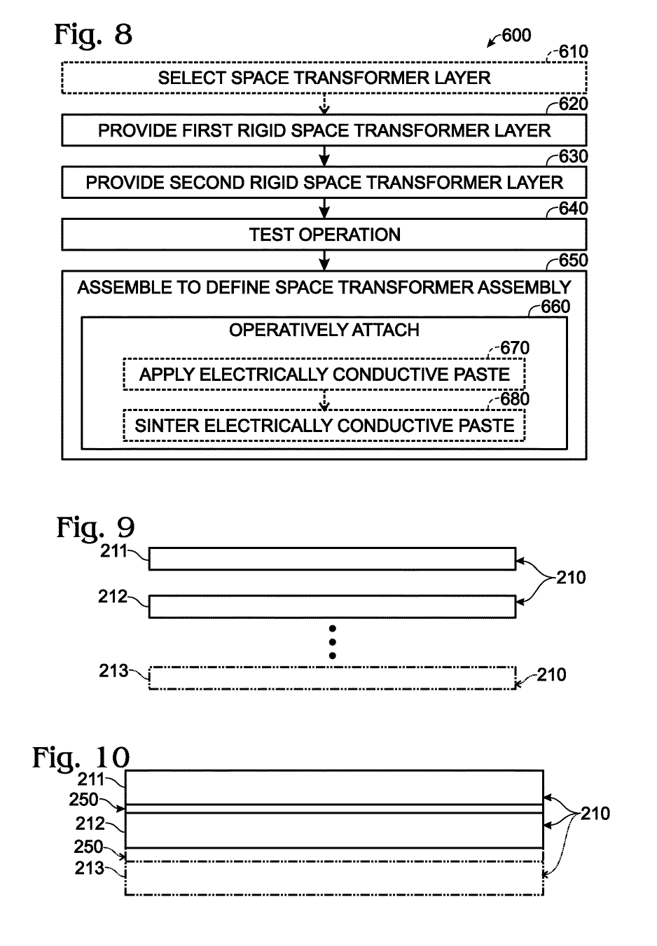

FIG. 8 is a flowchart depicting methods 600, according to the present disclosure, of fabricating a space transformer assembly, such as space transformer assembly 200 of FIGS. 1-3 and 5. FIGS. 9-10 are schematic views of a process flow illustrating portions of the method of FIG. 8. Methods 600 may include selecting a space transformer layer at 610 and include providing a first rigid space transformer layer at 620 and providing a second rigid space transformer layer at 630. Methods 600 further may include testing operation at 640 and include assembling the first rigid space transformer layer and the second rigid space transformer layer to define the space transformer assembly at 650.

Selecting the space transformer layer at 610 may include selecting the first rigid space transformer layer and/or selecting the second rigid space transformer layer. This may include selecting any suitable rigid space transformer layer, such as one or more rigid space transformer layers 210 that are illustrated in FIGS. 1-3 and 5 and discussed in more detail herein with reference thereto.

The selecting at 610 may include selecting from a selection, library, database, and/or inventory of rigid space transformer layers and may be based, at least in part, upon one or more selection criteria. In addition, the selecting at 610 may include selecting such that the first rigid space transformer layer is different from the second rigid space transformer layer. As a more specific example, the selecting at 610 may include selecting one rigid space transformer layer based upon one or more power delivery criteria and selecting another rigid space transformer layer based upon one or more data signal delivery criteria. As another example, the selecting at 610 may include designing, creating, and/or fabricating one or more rigid space transformer layers based, at least in part, on one or more design criteria.

Providing the first rigid space transformer layer at 620 and/or providing the second rigid space transformer layer at 630 may include providing in any suitable manner. As an example, the providing at 620 and/or the providing at 630 may include providing a respective pre-fabricated rigid space transformer layer. As another example, the providing at 620 and/or the providing at 630 may include fabricating a respective rigid space transformer layer. As yet another example, the providing at 620 and/or the providing at 630 may include providing a respective sub-structure and/or a respective finished, manufactured product as discussed herein.

It is within the scope of the present disclosure that the providing at 620 and the providing at 630 may be performed in any suitable order and/or with any suitable sequence during methods 600. As an example, methods 600 may include performing the providing at 620 and the providing at 630 at least partially concurrently, or even simultaneously.

It is also within the scope of the present disclosure that methods 600 may include providing any suitable number of rigid space transformer layers to form and/or define a space transformer assembly that includes the rigid space transformer layers. Examples of the number of rigid space transformer layers that may be included in space transformer assemblies according to the present disclosure are discussed herein with reference to FIG. 1.

The providing at 620 and the providing at 630 are illustrated in FIG. 9. As illustrated therein, a plurality of rigid space transformer layers 210 may be provided during methods 600. These rigid space transformer layers may include at least a first rigid space transformer layer 211 and a second rigid space transformer layer 212 and also may include any suitable number of additional rigid space transformer layers 213.

Testing operation at 640 may include testing any suitable property and/or characteristic of any suitable rigid space transformer layer, such as the first rigid space transformer layer and/or the second rigid space transformer layer, that may be assembled, during methods 600, to form and/or define the space transformer assembly. As examples, the testing at 640 may include visually inspecting the rigid space transformer layer, providing a test signal to the rigid space transformer layer, and/or receiving a resultant signal from the rigid space transformer layer. The testing at 640 may be performed subsequent to the selecting at 610, subsequent to the providing at 620, and/or subsequent to the providing at 630. Additionally or alternatively, the testing at 640 may be performed prior to the assembling at 650.

Assembling, at 650, the first rigid space transformer layer and the second rigid space transformer layer to define the space transformer assembly may include assembling at least two rigid space transformer layers in any suitable manner. As an example, the assembling at 650 may include operatively attaching, at 660, the first rigid space transformer layer to the second rigid space transformer layer. This may include operatively attaching with, via, and/or utilizing an attachment layer that extends between and/or electrically interconnects the first rigid space transformer layer and the second rigid space transformer layer. Examples of the attachment layer are discussed herein with reference to attachment layer 250 of FIG. 1.

The operatively attaching at 660 may include operatively attaching in any suitable manner. As an example, the operatively attaching at 660 may include adhering the first rigid space transformer layer to the second rigid space transformer layer. As another example, the operatively attaching at 660 may include positioning the attachment layer between the first rigid space transformer layer and the second rigid space transformer layer.

As yet another example, the first rigid space transformer layer may include a plurality of first contact pads and the second rigid space transformer layer may include a plurality of second contact pads. Under these conditions, the operatively attaching at 660 may include applying, at 670, an electrically conductive paste such that the electrically conductive paste extends between each of the plurality of first contact pads and a corresponding one of the plurality of second contact pads. Subsequently, the operatively attaching at 660 may include sintering, at 680, the electrically conductive paste to form and/or define a plurality of discrete attachment layer conduits. Each of the plurality of discrete attachment layer conduits may extend between a respective one of the plurality of first contact pads and the corresponding one of the plurality of second contact pads.

The assembling at 650 is illustrated in FIG. 10. As illustrated therein, the assembling at 650 may include operatively attaching a plurality of rigid space transformer layers 210 to one another via a corresponding plurality of attachment layers 250.

FIG. 11 is a flowchart depicting methods 700, according to the present disclosure, of planarizing a surface of an electronic device, such as a space transformer. FIGS. 12-21 are schematic views of portions of a process flow illustrating the method of FIG. 11. Methods 700 and/or the process flow of FIGS. 12-21 may be utilized to form and/or define a planarized space transforming structure, such as planarized space transforming structure 90 of FIG. 7. With this in mind, any of the structures, functions, and/or features of planarized space transforming structures that are disclosed herein with reference to FIG. 7 may be included in and/or utilized with methods 700 of FIG. 11 and/or the process flow of FIGS. 12-21 without departing from the scope of the present disclosure. Similarly, any of the structures, functions, and/or features that are discussed herein with reference to methods 700 of FIG. 11 and/or the process flow of FIGS. 12-21 may be included in and/or utilized with planarized space transforming structures 90 of FIG. 7 without departing from the scope of the present disclosure.

Methods 700 may include operatively attaching an interposer to a space transformer at 705 and include applying a resilient dielectric layer at 710 and applying a rigid dielectric layer at 715. Methods 700 further include planarizing at 720, applying an adhesive layer at 725, and applying a masking layer at 730. Methods 700 also include forming holes at 735 and applying an electrically conductive paste at 740. Methods 700 further may include separating the masking layer at 745, positioning a membrane structure at 750, and/or sintering at 755.

Operatively attaching the interposer to the space transformer at 705 may include operatively attaching the interposer to any suitable space transformer in any suitable manner. As an example, the space transformer may include a plurality of space transformer contact pads, and the operatively attaching at 705 may include operatively attaching such that the plurality of space transformer contact pads is operatively attached to, and in electrical communication with, a first plurality of interposer contact pads present on a first surface of the interposer. The interposer further may include a second plurality of interposer contact pads on a second surface of the interposer, and the second surface of the interposer may be opposed to, or may face away from the first surface of the interposer.

The operatively attaching at 705 is illustrated in FIG. 12. Therein, a space transformer 100 is operatively attached to an interposer 510. The space transformer includes a plurality of space transformer contact pads 320, which also may be referred to herein as electrically conductive contact pads 320. The interposer includes a first surface 512, including a first plurality of interposer contact pads 516, and a second surface 514, including a second plurality of interposer contact pads 518. In the context of FIG. 4, first surface 512 also may be referred to as an upper surface 512, and second surface 514 also may be referred to herein as a lower surface 514. Similarly, the first plurality of interposer contact pads 516 also may be referred to herein as upper interposer contact pads 516, and the second plurality of interposer contact pads 518 also may be referred to herein as lower interposer contact pads 518.

Applying the resilient dielectric layer at 710 may include applying any suitable resilient dielectric layer to any suitable electronic device, such as to the interposer, when present, or directly to the space transformer. This may include applying the resilient dielectric layer such that the resilient dielectric layer extends conformally across, or covers, the electronic device. When the applying at 710 includes applying the resilient dielectric layer to the interposer, the applying at 710 further may include applying such that the resilient dielectric layer extends conformally across, or covers, the second surface of the interposer and the second plurality of interposer contact pads. When the applying at 710 includes applying the resilient dielectric layer directly to the space transformer, the applying at 710 further may include applying such that the resilient dielectric layer extends conformally across, or covers, at least a portion of a surface of the space transformer and/or the electrically conductive contact pads.

The applying at 710 may be accomplished in any suitable manner. As examples, the applying at 710 may include brushing, spraying, spreading, casting, and/or spin-coating a first dielectric liquid onto the interposer and subsequently at least partially solidifying, drying, and/or cross-linking the first dielectric liquid to form and/or define the resilient dielectric layer. Additionally or alternatively, the applying at 710 may include adhering a pre-formed, or pre-defined, resilient dielectric layer to the interposer. This may include adhering with a separate adhesive and/or adhering via an inherent adhesiveness of the pre-formed, or pre-defined, resilient dielectric layer.

The applying at 710 is illustrated in FIG. 13. Therein, a resilient dielectric layer 530 may coat, cover, and/or extend conformally across interposer 510 and/or second surface 514 thereof. Alternatively, and when interposer 510 is not present (such as when methods 700 do not include the operatively attaching at 705), resilient dielectric layer 530 may extend directly across the upper surface of space transformer 100 and/or across electrically conductive contact pads 320.

Regardless, and as illustrated, resilient dielectric layer 530 may have a nonplanar upper surface 532 and/or an opposed nonplanar lower surface 534. The nonplanar nature of upper surface 532 and/or of lower surface 534 may be caused by the nonplanarity of second interposer surface 514, by the projection of the second plurality of interposer contact pads 518 from the second interposer surface, and/or by the projection of electrically conductive contact pads 320 from space transformer 100.

Applying the rigid dielectric layer at 715 may include applying the rigid dielectric layer such that the resilient dielectric layer extends between the electronic device and the rigid dielectric layer and/or such that the resilient dielectric layer extends between the space transformer and the rigid dielectric layer. Additionally or alternatively, the applying at 715 may include applying the rigid dielectric layer such that the rigid dielectric layer extends conformally across the resilient dielectric layer and/or such that the rigid dielectric layer extends in contact with the upper surface of the resilient dielectric layer.

The applying at 715 may be accomplished in any suitable manner. As an example, the applying at 715 may include brushing, spraying, spreading, casting, and/or spin-coating a second dielectric liquid onto the resilient dielectric layer and subsequently at least partially solidifying, drying, and/or cross-linking the second dielectric liquid to form and/or define the rigid dielectric layer.

The applying at 715 is illustrated in FIG. 14. Therein, a rigid dielectric layer 536 extends across, or extends conformally across, resilient dielectric layer 530. The rigid dielectric layer includes an exposed surface 538, and the exposed surface may be nonplanar due to the nonplanar nature of upper surface 532 of resilient dielectric layer 530.

Planarizing at 720 may include planarizing the exposed surface of the rigid dielectric layer. This may include planarizing to produce and/or generate a planarized surface on the rigid dielectric layer. Subsequent to the planarizing at 720, the rigid dielectric layer also may be referred to herein as a planarized rigid dielectric layer, and the planarized surface may be planar, or at least substantially planar, as discussed herein with respect to FIG. 7.

The planarizing at 720 may be accomplished in any suitable manner. As an example, the planarizing at 720 may include abrading and/or polishing the exposed surface to produce and/or generate the planarized surface. As another example, the planarizing at 720 may include removing at least a portion of the rigid dielectric layer to produce and/or generate the planarized surface. As yet another example, the planarizing at 720 may include cutting away at least a portion of the rigid dielectric layer, such as via utilizing a suitable surface plane, to produce and/or generate the planarized surface. As additional examples, the planarizing at 720 may include lapping, grinding, polishing, and/or milling the rigid dielectric layer to produce and/or generate the planarized surface.

The planarizing at 720 is illustrated in FIG. 15. Therein, rigid dielectric layer 536 of FIG. 11 has been planarized to generate planarized rigid dielectric layer 540 that includes planarized surface 544. Planarized surface 544 also may be referred to herein (e.g., in the context of FIG. 7) as a planarized lower surface.

Applying the adhesive layer at 725 may include applying any suitable adhesive layer to the planarized surface of the rigid dielectric layer. This may include applying the adhesive layer such that the adhesive layer extends across the planarized surface and/or applying the adhesive layer such that the planarized dielectric layer extends between the adhesive layer and the resilient dielectric layer.

The applying at 725 may be accomplished in any suitable manner. As an example, the applying at 725 may include brushing, spraying, spreading, casting, and/or spin-coating a liquid adhesive onto the planarized surface and subsequently at least partially solidifying, drying, and/or cross-linking the liquid adhesive to form and/or define the adhesive layer. As another example, the applying at 725 may include locating a pre-formed and/or pre-defined adhesive film on the planarized surface to form and/or define the adhesive layer.

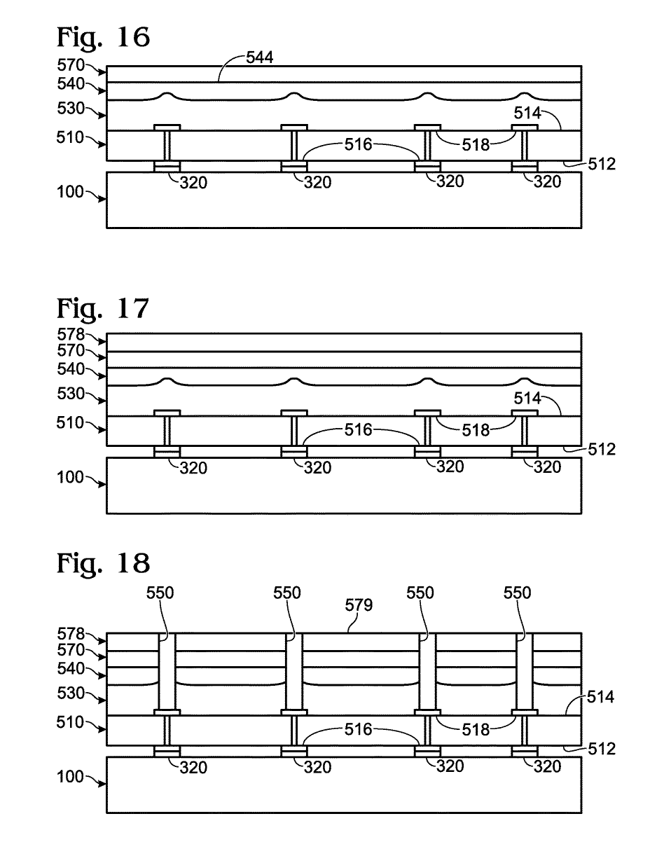

The applying at 725 is illustrated in FIG. 16. Therein, an adhesive layer 570 has been applied to planarized surface 544 of rigid dielectric layer 540.

Applying the masking layer at 730 may include applying any suitable masking layer to the adhesive layer. This may include applying the masking layer such that the adhesive layer extends between the planarized surface of the rigid dielectric layer and the masking layer and/or applying the masking layer to an exposed surface of the adhesive layer.

The applying at 730 may be accomplished in any suitable manner. As an example, the applying at 730 may include brushing, spraying, spreading, casting, and/or spin-coating a liquid masking layer onto the adhesive layer and subsequently at least partially solidifying, drying, and/or cross-linking the liquid masking layer to form and/or define the masking layer. As another example, the applying at 725 may include locating a pre-formed and/or pre-defined masking film on the adhesive layer to form and/or define the masking layer. Examples of the pre-formed and/or pre-defined masking film include a polyester film and/or a plastic film.

The applying at 730 is illustrated in FIG. 17. Therein, a masking layer 578 has been applied to adhesive layer 570 such that the adhesive layer extends between the masking layer and planarized rigid dielectric layer 540.

Forming holes at 735 may include forming a plurality of holes in and/or within the masking layer, the adhesive layer, the planarized rigid dielectric layer, and the resilient dielectric layer. Each hole may extend from an exposed surface of the masking layer, through the masking layer, through the adhesive layer, through the planarized rigid dielectric layer, through the resilient dielectric layer, and into contact with a corresponding interposer contact pad of the interposer, when present, and/or into contact with a corresponding electrically conductive contact pad of the space transformer.

The forming at 735 may be accomplished in any suitable manner. As an example, the forming at 735 may include laser drilling the holes. As another example, the forming at 735 may include lithographically patterning and/or forming the holes. As yet another example, the forming at 735 may include etching the holes.

The forming at 735 is illustrated in FIG. 18. Therein, holes 550 extend from an exposed surface 579 of masking layer 578, through masking layer 578, through adhesive layer 570, through planarized rigid dielectric layer 540, through resilient dielectric layer 530, and into contact with interposer contact pads 518, when present, or into contact with electrically conductive contact pads 320 when interposer 510 is not utilized.

Applying the electrically conductive paste at 740 may include applying the electrically conductive paste to the plurality of holes. This may include applying the electrically conductive paste such that the electrically conductive paste extends within each of the holes and/or defines a plurality of discrete electrical conductors. Each of the discrete electrical conductors may extend within a corresponding hole, from the exposed surface of the masking layer, and to and/or into contact, or into electrical contact, with the corresponding interposer contact pad.

The applying at 740 may be accomplished in any suitable manner. As an example, the applying at 740 may include selectively applying the electrically conductive paste only, or at least substantially only, to the plurality of holes. As another example, the applying at 740 may include applying discrete and/or separate volumes of the electrically conductive paste to each of the plurality of holes and/or such that each of the discrete and/or separate volumes of electrically conductive paste extends within a corresponding one of the plurality of holes. As yet another example, the applying at 740 may include spreading the electrically conductive paste across the exposed surface of the masking layer such that the electrically conductive paste is pressed into the holes and/or flows into the holes.

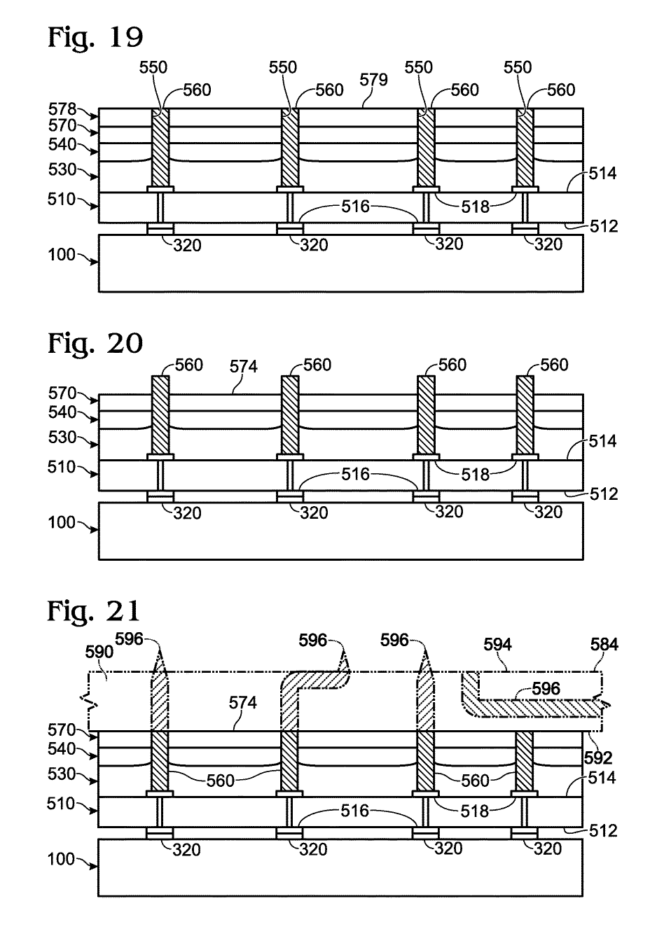

The applying at 740 is illustrated in FIG. 19. Therein, an electrically conductive paste 560 extends within each hole 550. In addition, the electrically conductive paste extends between exposed surface 579 of masking layer 578 and interposer contact pads 518, when present, or between exposed surface 579 and electrically conductive contact pads 320 when interposer 510 is not utilized.

Separating the masking layer at 745 may include separating the masking layer from the adhesive layer and may be performed subsequent to the applying at 740. The separating at 745 further may include separating such that each of the plurality of discrete electrical conductors defined by the electrically conductive paste may extend and/or project from an exposed surface of the adhesive layer.

The separation at 745 may be accomplished in any suitable manner. As an example, the separation at 745 may include peeling the masking layer from the adhesive layer. As another example, the separation at 745 may include dissolving the masking layer. In general, the separating at 745 includes separating without disturbing, without substantially disturbing, without removing, and/or without removing an entirety of, the adhesive layer.

The separating at 745 is illustrated in FIG. 20. Therein, masking layer 578 of FIG. 19 has been separated from adhesive layer 570. Subsequent to this separation, the discrete electrical conductors that are defined by electrically conductive paste 560 extend and/or project from an exposed surface 579 of adhesive layer 570. Exposed surface 579 also may be referred to herein as a lower adhesive layer surface 574 (e.g., in the context of FIG. 7).

Positioning the membrane structure at 750 may include positioning the membrane structure on the exposed surface of the adhesive layer and may be performed subsequent to the separating at 745. The membrane structure may include a dielectric membrane, which defines an upper membrane surface and an opposed lower membrane surface. The membrane structure further may include a plurality of membrane conductors, which are discussed in more detail herein. The positioning at 750 may include positioning such that each of the plurality of discrete electrical conductors electrically contacts a corresponding one of the plurality of membrane conductors. Additionally or alternatively, the positioning at 750 also may include adhering the membrane structure to the planarized surface of the rigid dielectric layer, such as via and/or utilizing the adhesive layer.

The positioning at 750 is illustrated in FIG. 21. Therein, a membrane structure 584 is positioned on exposed surface 579 of adhesive layer 570. The membrane structure includes a dielectric membrane 590 that includes an upper membrane surface 592 and an opposed lower membrane surface 594 (e.g., in the orientation that is illustrated in FIG. 4). The membrane structure also includes a plurality of membrane electrical conductors 596, which are discussed in more detail herein. The membrane structure is positioned such that each of the membrane electrical conductors electrically contacts a corresponding discrete electrical conductor that is defined by electrically conductive paste 560.

Sintering at 755 may include sintering the electrically conductive paste to solidify the electrically conductive paste. This may include sintering to form and/or generate a plurality of solidified discrete electrical conductors and may be performed subsequent to the positioning at 750. Subsequent to the sintering at 755, each of the solidified discrete electrical conductors may operatively attach the membrane structure to the interposer, when present, and electrically interconnect the membrane structure and the interposer, when present. Alternatively, each of the solidified discrete electrical conductors may operatively attach the membrane structure to the space transformer and electrically interconnect the membrane structure and the interposer.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently. It is also within the scope of the present disclosure that the blocks, or steps, may be implemented as logic, which also may be described as implementing the blocks, or steps, as logics. In some applications, the blocks, or steps, may represent expressions and/or actions to be performed by functionally equivalent circuits or other logic devices. The illustrated blocks may, but are not required to, represent executable instructions that cause a computer, processor, and/or other logic device to respond, to perform an action, to change states, to generate an output or display, and/or to make decisions.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entity in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” may mean A alone, B alone, C alone, A and B together, A and C together, B and C together, A, B and C together, and optionally any of the above in combination with at least one other entity.

In the event that any patents, patent applications, or other references are incorporated by reference herein and (1) define a tend in a manner that is inconsistent with and/or (2) are otherwise inconsistent with, either the non-incorporated portion of the present disclosure or any of the other incorporated references, the non-incorporated portion of the present disclosure shall control, and the term or incorporated disclosure therein shall only control with respect to the reference in which the term is defined and/or the incorporated disclosure was present originally.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

Illustrative, non-exclusive examples of space transformers, planarization layers for space transformers, and methods according to the present disclosure are presented in the following enumerated paragraphs. It is within the scope of the present disclosure that an individual step of a method recited herein, including in the following enumerated paragraphs, may additionally or alternatively be referred to as a “step for” performing the recited action.

A1. A space transformer assembly, comprising:

a first rigid space transformer layer including:

(i) a planar first layer upper surface;

(ii) a planar first layer lower surface that is opposed to the first layer upper surface;

(iii) a plurality of first upper contact pads on the first layer upper surface;

(iv) a plurality of first lower contact pads on the first layer lower surface; and

(v) a plurality of first electrical conductors oriented to conduct a plurality of electric currents between the plurality of first upper contact pads and the plurality of first lower contact pads;

a second rigid space transformer layer including:

(i) a planar second layer upper surface that faces toward the first layer lower face;

(ii) a planar second layer lower surface that is opposed to the second layer upper surface;

(iii) a plurality of second layer upper contact pads on the second layer upper surface;

(iv) a plurality of second layer lower contact pads on the second layer lower surface; and

(v) a plurality of second electrical conductors oriented to conduct the plurality of electric currents between the plurality of second layer upper contact pads and the plurality of second layer lower contact pads; and

an attachment layer that extends between the first rigid space transformer layer and the second rigid space transformer layer, operatively attaches the first rigid space transformer layer to the second rigid space transformer layer, and electrically interconnects each of the plurality of first lower contact pads to a corresponding one of the plurality of second layer upper contact pads.

A2. The assembly of paragraph A1, wherein the first rigid space transformer layer is a first subassembly of the space transformer assembly.

A3. The assembly of any of paragraphs A1-A2, wherein the second rigid space transformer layer is a second subassembly of the space transformer assembly.

A4. The assembly of any of paragraphs A1-A3, wherein the first rigid space transformer layer and the second rigid space transformer layer are assembled, via the attachment layer, to define the space transformer assembly.

A5. The assembly of any of paragraphs A1-A4, wherein the first rigid space transformer layer and the second rigid space transformer layer both are finished, manufactured products that are operatively attached to one another, via the attachment layer, to define the space transformer assembly.

A6. The assembly of any of paragraphs A1-A5, wherein at least one of:

(i) the plurality of first upper contact pads projects from the first layer upper surface;

(ii) the plurality of first lower contact pads projects from the first layer lower surface;

(iii) the plurality of second layer upper contact pads projects from the second layer upper surface; and

(iv) the plurality of second layer lower contact pads projects from the second layer lower surface.

A7. The assembly of any of paragraphs, A1-A6, wherein the space transformer assembly further includes an air gap that separates at least a portion of the first layer lower surface from at least a portion of the second layer upper surface.

A8. The assembly of any of paragraphs A1-A7, wherein an average pitch, or spacing, of the plurality of second layer lower contact pads is less than a threshold fraction of an average pitch, or spacing, of the plurality of first upper contact pads.

A9. The assembly of any of paragraphs A1-A8, wherein an average distance between each of the plurality of second layer lower contact pads and a closest other of the plurality of second lower contact pads is less than a/the threshold fraction of an average distance between each of the plurality of first upper contact pads and a closest other of the plurality of first upper contact pads.

A10. The assembly of any of paragraphs A1-A9, wherein an average pitch, or spacing, of the plurality of first upper contact pads is less than a/the threshold fraction of an average pitch, or spacing, of the plurality of second layer lower contact pads.

A11. The assembly of any of paragraphs A1-A10, wherein an average distance between each of the plurality of first upper contact pads and a closest other of the plurality of first upper contact pads is less than a/the threshold fraction of an average distance between each of the plurality of second layer lower contact pads and a closest other of the plurality of second layer lower contact pads.

A12. The assembly of any of paragraphs A8-A11, wherein the threshold fraction is at least one of:

(i) at least 1%, at least 5%, at least 10%, at least 20%, or at least 25% of the average pitch, or spacing, of the plurality of first upper contact pads; and

(ii) at most 400%, at most 300%, at most 200%, at most 100%, at most 50%, at most 40%, at most 30%, at most 20%, at most 10%, at most 5%, at most 1%, or at most 0.1% of the average pitch, or spacing, of the plurality of first upper contact pads.

A13. The assembly of any of paragraphs A1-A12, wherein a location of each of the plurality of first lower contact pads corresponds to a location of each of the plurality of second layer upper contact pads.

A14. The assembly of any of paragraphs A1-A13, wherein a layout of the plurality of first lower contact pads is a mirror image of a layout of the plurality of second layer upper contact pads.

A15. The assembly of any of paragraphs A1-A14, wherein the attachment layer extends between and electrically interconnects each of the plurality of first lower contact pads to a corresponding one of the plurality of second layer upper contact pads.

A16. The assembly of any of paragraphs A1-A15, wherein each of the plurality of first lower contact pads is opposed to a/the corresponding one of the plurality of second layer upper contact pads.

A17. The assembly of any of paragraphs A1-A16, wherein the plurality of first electrical conductors of the first rigid space transformer layer includes at least one of:

(i) at least one first electrically conductive via that extends perpendicular, or at least substantially perpendicular, to the first layer upper surface and between a via contact pad of the plurality of first upper contact pads and a corresponding via contact pad of the plurality of first lower contact pads; and

(ii) at least one first electrically conductive trace that extends parallel, or at least substantially parallel, to the first layer upper surface and between a trace contact pad of the plurality of first upper contact pads and a corresponding trace contact pad of the plurality of first lower contact pads.

A18. The assembly of any of paragraphs A1-A17, wherein the plurality of second electrical conductors of the second rigid space transformer layer includes at least one of:

(i) at least one second electrically conductive via that extends perpendicular, or at least substantially perpendicular, to the second layer upper surface and between a via contact pad of the plurality of second layer upper contact pads and a corresponding via contact pad of the plurality of second layer lower contact pads; and

(ii) at least one second electrically conductive trace that extends parallel, or at least substantially parallel, to the second layer upper surface and between a trace contact pad of the plurality of second layer upper contact pads and a corresponding trace contact pad of the plurality of second layer lower contact pads.

A19. The assembly of any of paragraphs A1-A18, wherein the first layer upper surface is parallel, or at least substantially parallel, to at least one, optionally both, and further optionally all three, of:

(i) the first layer lower surface;

(ii) the second layer upper surface; and

(iii) the second layer lower surface.

A20. The assembly of any of paragraphs A1-A19, wherein the second layer upper surface is parallel, or at least substantially parallel, to at least one, optionally both, and further optionally all three, of:

(i) the first layer upper surface;

(ii) the first layer lower surface; and

(iii) the second layer lower surface.

A21. The assembly of any of paragraphs A1-A20, wherein at least one of the first rigid space transformer layer and the second rigid space transformer layer is configured to convey a power signal therethrough, optionally wherein the power signal includes at least one of a direct current power signal and an alternating current power signal.

A22. The assembly of paragraph A21, wherein the power signal has a magnitude of at least 0.001 amps, at least 0.01 amps, at least 0.1 amps, at least 0.5 amps, at least 1 amp, at least 5 amps, at least 10 amps, at least 25 amps, at least 50 amps, at least 75 amps, or at least 100 amps.

A23. The assembly of any of paragraphs A1-A22, wherein at least one of the first rigid space transformer layer and the second rigid space transformer layer is configured to convey a data signal therethrough, optionally wherein the data signal includes at least one of a direct current data signal and an alternating current data signal.

A24. The assembly of paragraph A23, wherein the alternating current data signal is a high frequency alternating current data signal, and optionally a radio frequency, or RF, data signal.

A25. The assembly of paragraph A24, wherein the high frequency alternating current data signal has a frequency of at least 1 kilohertz, at least 10 kilohertz, at least 100 kilohertz, at least 1 megahertz, at least 10 megahertz, at least 100 megahertz, at least 1 gigahertz, at least 10 gigahertz, or at least 100 gigahertz.

A26. The assembly of any of paragraphs A1-A25, wherein at least one of the first rigid space transformer layer and the second rigid space transformer layer is configured to convey a/the direct current power signal therethrough, and further wherein the other of the first rigid space transformer layer and the second rigid space transformer layer is configured to convey a/the alternating current data signal therethrough.

A27. The assembly of any of paragraphs A1-A26, wherein the space transformer assembly includes a plurality of rigid space transformer layers including at least one of:

(i) at least 2, at least 4, at least 6, at least 8, at least 10, at least 12, at least 14, at least 16, at least 18, at least 20, at least 25, or at least 30 rigid space transformer layers; and

(ii) at most 200, at most 175, at most 150, at most 125, at most 100, at most 90, at most 80, at most 70, at most 60, at most 50, at most 40, at most 30, or at most 20 rigid space transformer layers.

A28. The assembly of any of paragraphs A1-A27, wherein a corresponding attachment layer:

(i) extends between each of the plurality of rigid space transformer layers and at least one other of the plurality of rigid space transformer layers;

(ii) operatively attaches each of the plurality of rigid space transformer layers to at the least one other of the plurality of rigid space transformer layers; and

(iii) electrically interconnects each of the plurality of rigid space transformer layers to the at least one other of the plurality of rigid space transformer layers.

A29. The assembly of any of paragraphs A1-A28, wherein the space transformer assembly further includes at least one intermediate rigid space transformer layer that extends between the first rigid space transformer layer and the second rigid space transformer layer.

A30. The assembly of any of paragraphs A1-A29, wherein the space transformer assembly further includes at least one upper rigid space transformer layer that is operatively attached to the planar first layer upper surface.

A31. The assembly of any of paragraphs A1-A30, wherein the space transformer assembly further includes at least one lower rigid space transformer layer that is operatively attached to the planar second layer lower surface.

A32. The assembly of any of paragraphs A1-A31, wherein the first rigid space transformer layer includes, and optionally is, a modular capacitor bank.

A33. The assembly of paragraph A32, wherein the modular capacitor bank includes a plurality of capacitors.

A34. The assembly of paragraph A33, wherein the plurality of capacitors includes at least one of:

(i) a plurality of surface mount capacitors; and

(ii) a plurality of thin film capacitors.

A35. The assembly of any of paragraphs A33-A34, wherein at least a portion of the plurality of capacitors extends from the planar first layer upper surface.

A36. The assembly of any of paragraphs A33-A35, wherein each of the plurality of capacitors is in electrical communication with a corresponding pair of the plurality of first electrical conductors.

A37. The assembly of any of paragraphs A1-A36, wherein the space transformer assembly further includes a flexible membrane layer that is operatively attached to the second layer lower surface of the second rigid space transformer layer.

A38. The assembly of paragraph A37, wherein the membrane layer includes:

(i) a membrane upper surface that faces toward the second layer lower surface;

(ii) a membrane lower surface that is opposed to the membrane upper surface;

(iii) a plurality of membrane upper contact pads on the membrane upper surface;

(iv) a plurality of membrane lower contact pads on the membrane lower surface; and

(v) a plurality of membrane electrical conductors oriented to conduct a plurality of electric currents between the plurality of membrane upper contact pads and the plurality of membrane lower contact pads;

wherein a relative orientation of the plurality of membrane upper contact pads corresponds to a relative orientation of the plurality of second layer lower contact pads, and further wherein a relative orientation of the plurality of membrane lower contact pads is selected to adapt the plurality of second layer lower contact pads to a desired relative orientation.

A39. The assembly of any of paragraphs A1-A36, wherein the second rigid space transformer layer is instead a flexible membrane layer.

A40. The assembly of paragraph A39, wherein the membrane layer is configured to customization of a contact pad layout on the second layer lower surface.

A41. The assembly of any of paragraphs A1-A40, wherein at least one of the first rigid space transformer layer and the second rigid space transformer layer includes a printed circuit board.

A42. The assembly of any of paragraphs A1-A41, wherein at least one of the first rigid space transformer layer and the second rigid space transformer layer includes a high density interconnect layer.

A43. The assembly of any of paragraphs A1-A42, wherein the plurality of first upper contact pads includes a plurality of metallic first upper contact pads.

A44. The assembly of any of paragraphs A1-A43, wherein the plurality of first lower contact pads includes a plurality of metallic first lower contact pads.

A45. The assembly of any of paragraphs A1-A44, wherein the plurality of first electrical conductors includes a first plurality of metallic electrical conductors.

A46. The assembly of any of paragraphs A1-A45, wherein the first rigid space transformer layer further includes a first dielectric body that defines the first layer upper surface and the first layer lower surface and that supports the plurality of first upper contact pads, the plurality of first lower contact pads, and the plurality of first electrical conductors.

A47. The assembly of any of paragraphs A1-A46, wherein the plurality of second layer upper contact pads includes a plurality of metallic second layer upper contact pads.

A48. The assembly of any of paragraphs A1-A47, wherein the plurality of second layer lower contact pads includes a plurality of metallic second layer lower contact pads.

A49. The assembly of any of paragraphs A1-A48, wherein the plurality of second electrical conductors includes a second plurality of metallic electrical conductors.

A50. The assembly of any of paragraphs A1-A49, wherein the second rigid space transformer layer further includes a second dielectric body that defines the second layer upper surface and the second layer lower surface and that supports the plurality of second layer upper contact pads, the plurality of second layer lower contact pads, and the plurality of second electrical conductors.

A51. The assembly of any of paragraphs A1-A50, wherein the attachment layer is an electrically conductive attachment layer.

A52. The assembly of any of paragraphs A1-A51, wherein the attachment layer includes a plurality of discrete electrical conductors extending between each of the plurality of first lower contact pads and the corresponding one of the plurality of second layer upper contact pads, optionally wherein the plurality of discrete electrical conductors includes at least one of a sintered metal and a sintered copper paste.

A53. The assembly of any of paragraphs A1-A52, wherein the attachment layer includes an anisotropically conductive film configured to conduct an electric current in a direction that is perpendicular to the first layer lower surface and to resist conduction of the electric current in a direction that is parallel to the first layer lower surface.

A54. The assembly of any of paragraphs A1-A53, wherein the attachment layer extends directly between the first rigid space transformer layer and the second rigid space transformer layer.

A55. The assembly of any of paragraphs A1-A54, wherein the attachment layer extends in direct physical contact with at least a portion of the first rigid space transformer layer and at least a portion of the second rigid space transformer layer.

A56. The assembly of any of paragraphs A1-A55, wherein the attachment layer extends across an entirety of a space that is defined between the first layer lower surface and the second layer upper surface.

A57. The assembly of any of paragraphs A1-A56, wherein the attachment layer is selectively located to extend only between each of the plurality of first lower contact pads and corresponding ones of the plurality of second layer upper contact pads.

B1. A space transformer, comprising:

a space transformer body, including:

(i) a rigid dielectric body including an upper surface and an opposed planar lower surface;

(ii) a plurality of electrically conductive contact pads on the planar lower surface;

(iii) a plurality of electrically conductive attachment points supported by the rigid dielectric body; and

(iv) a plurality of body electrical conductors supported by the rigid dielectric body, wherein each of the plurality of body electrical conductors extends between a selected one of the plurality of electrically conductive attachment points and a corresponding one of the plurality of electrically conductive contact pads; and

a flex cable assembly including a plurality of ribbon electrical conductors defining a plurality of cable ribbons, wherein each of the plurality of cable ribbons includes a corresponding subset of the plurality of ribbon electrical conductors, wherein the plurality of cable ribbons defines a layered stack of cable ribbons, and further wherein each of the plurality of ribbon electrical conductors includes a body-proximal conductor end, which is operatively attached to a corresponding one of the plurality of electrically conductive attachment points, and a body-distal conductor end.

B2. The space transformer of paragraph B1, wherein the flex cable assembly includes a body-proximal cable end and a body-distal cable end, wherein the body-proximal cable end is proximal the space transformer body relative to the body-distal cable end.

B3. The space transformer of paragraph B2, wherein the flex cable assembly is configured to provide a threshold displacement, or at least the threshold displacement, of the body-proximal cable end relative to the body-distal cable end, via flex of the flex cable assembly, for a given force applied to the space transformer body.

B4. The space transformer of paragraph B3, wherein the threshold displacement is at least one of:

(i) at least 1 millimeter (mm), at least 2 mm, at least 4 mm, at least 5 mm, at least 10 mm, at least 15 mm, at least 20 mm, at least 25 mm, or at least 30 mm; and

(ii) at most 50 mm, at most 40 mm, at most 30 mm, at most 25 mm, or at most 20 mm.

B5. The space transformer of any of paragraphs B3-B4, wherein the force is at least one of:

(i) at least 1 Newton (N), at least 2 N, at least 3 N, at least 4 N, at least 5 N, at least 6 N, at least 8 N, or at least 10 N; and

(ii) at most 1000 N, at most 900 N, at most 800 N, at most 700 N, at most 600 N, at most 500 N, at most 400 N, at most 300 N, at most 200 N, at most 100 N, at most 50 N, at most 20 N, at most 18 N, at most 16 N, at most 14 N, at most 12 N, at most 10 N, at most 8 N, at most 6 N, or at most 4 N.

B6. The space transformer of any of paragraphs B2-B5, wherein the plurality of ribbon electrical conductors of the flex cable assembly together are configured to convey at least a threshold electric current magnitude between the body-proximal cable end and the body-distal cable end.

B7. The space transformer of paragraph B6, wherein the threshold electric current magnitude is at least one of:

(i) at least 1 milliAmp (mA), at least 50 mA, at least 100 mA, at least 500 mA, at least 1 Amp (A), at least 25 A, at least 50 A, at least 100 A, at least 200 A, at least 300 A, at least 400 A, at least 500 A, at least 600 A, at least 700 A, at least 800 A, at least 900 A, at least 1000 A, or at least 1500 A; and

(ii) at most 2500 A, at most 2000 A, at most 1800 A, at most 1600 A, at most 1400 A, at most 1200 A, at most 1000 A, or at most 800 A.

B8. The space transformer of any of paragraphs B1-B7, wherein at least two ribbon electrical conductors of the plurality of ribbon electrical conductors are electrically shorted together, within the space transformer body, such that the at least two ribbon electrical conductors are in electrical communication with a single electrically conductive contact pad of the plurality of electrically conductive contact pads.

B9. The space transformer of any of paragraphs B1-B8, wherein the body-proximal ends of at least two ribbon electrical conductors of the plurality of ribbon electrical conductors are operatively attached to a single electrically conductive attachment point.

B10. The space transformer of any of paragraphs B8-B9, wherein the at least two ribbon electrical conductors extend within the same cable ribbon of the plurality of cable ribbons.

B11. The space transformer of any of paragraphs B8-B10, wherein the at least two ribbon electrical conductors extend within different cable ribbons of the plurality of cable ribbons.

B12. The space transformer of any of paragraphs B1-B11, wherein at least one body electrical conductor of the plurality of body electrical conductors electrically interconnects a given electrically conductive contact pad of the plurality of electrically conductive contact pads with at least two electrically conductive attachment points of the plurality of electrically conductive attachment points.

B13. The space transformer of any of paragraphs B1-B12, wherein a respective air gap extends between each of the plurality of cable ribbons and an adjacent cable ribbon of the plurality of cable ribbons.

B14. The space transformer of paragraph B13, wherein the air gap extends along at least a threshold fraction of a length of the flex cable assembly as measured between a/the body-proximal cable end and a/the body-distal cable end.

B15. The space transformer of paragraph B14, wherein the threshold fraction of the length of the flex cable assembly includes at least 50%, at least 60%, at least 70%, at least 80%, at least 90%, at least 95%, or at least 99% of the length of the flex cable assembly.

B16. The space transformer of any of paragraphs B1-B15, wherein an intermediate portion of each of the plurality of cable ribbons is distinct from an intermediate portion of each other of the plurality of cable ribbons, optionally wherein the intermediate portion extends between a/the body-proximal cable end and a/the body-distal cable end.

B17. The space transformer of any of paragraphs B1-B16, wherein each of the plurality of cable ribbons further includes a respective ribbon insulator that surrounds the corresponding subset of the plurality of ribbon electrical conductors.

B18. The space transformer of paragraph B17, wherein the respective ribbon insulator electrically isolates each ribbon electrical conductor in the corresponding subset of the plurality of ribbon electrical conductors from each other ribbon electrical conductor in the corresponding subset of the plurality of ribbon electrical conductors.

B19. The space transformer of any of paragraphs B17-B18, wherein the respective ribbon insulator electrically isolates the corresponding subset of the plurality of ribbon electrical conductors from a remainder of the plurality of ribbon electrical conductors.

B20. The space transformer of any of paragraphs B17-B19, wherein the ribbon insulator is formed from at least one of a dielectric material, a flexible material, and a polymeric material.

B21. The space transformer of any of paragraphs B1-B20, wherein the flex cable assembly further includes a rigid interface structure that is operatively attached to the plurality of body electrical conductors, optionally wherein the rigid interface structure defines a/the body-distal cable end of the flex cable assembly.

B22. The space transformer of paragraph B21, wherein the rigid interface structure includes a plurality of rigid interface structure layers.

B23. The space transformer of paragraph B22, wherein at least a subset of the plurality of rigid interface structure layers is operatively attached to a corresponding one of the plurality of cable ribbons.

B24. The space transformer of any of paragraphs B22-B23, wherein at least a subset of the plurality of rigid interface structure layers includes a plurality of electrically conductive interface structure attachment points that form is a corresponding plurality of electrical connections with the body-distal end of the corresponding subset of the plurality of ribbon electrical conductors of a given cable ribbon of the plurality of cable ribbons.

B25. The space transformer of any of paragraphs B22-B24, wherein at least a subset of the plurality of rigid interface structure layers includes an interface structure printed circuit board.

B26. The space transformer of any of paragraphs B22-B25, wherein the plurality of rigid interface structure layers is stacked to define the rigid interface structure.

B27. The space transformer of any of paragraphs B22-B26, wherein the plurality of rigid interface layers is operatively attached to one another to define the rigid interface structure.

B28. The space transformer of any of paragraphs B21-B27, wherein the rigid interface structure further includes a plurality of interface structure contact pads, wherein each of the plurality of interface structure interface pads is electrically connected to a corresponding one of the plurality of ribbon electrical conductors.

B29. The space transformer of any of paragraphs B1-B28, wherein the space transformer body includes the space transformer assembly of any of paragraphs A1-A57.

B30. The space transformer of paragraph B29, wherein a first subset of the plurality of electrically conductive attachment points is defined by the first rigid space transformer layer.

B31. The space transformer of any of paragraphs B29-B30, wherein a second subset of the plurality of electrically conductive attachment points is defined by the second rigid space transformer layer.

B32. The space transformer of any of paragraphs B1-B31, wherein the rigid dielectric body is formed from an electrically insulating material.

B33. The space transformer of any of paragraphs B1-B32, wherein the rigid dielectric body is formed from a plurality of stacked space transformer layers.

B34. The space transformer of any of paragraphs B1-B33, wherein the plurality of electrically conductive contact pads includes a plurality of metallic contact pads.

B35. The space transformer of any of paragraphs B1-B34, wherein the plurality of electrically conductive contact pads extends from the planar lower surface.

B36. The space transformer of any of paragraphs B1-B35, wherein at least a portion of the plurality of electrically conductive attachment points extends on, or from, the upper surface of the rigid dielectric body.

B37. The space transformer of any of paragraphs B1-B36, wherein the space transformer body further includes at least one edge that extends between the upper surface and the planar lower surface, wherein at least a portion of the plurality of electrically conductive attachment points extends on, or from, the at least one edge.

B38. The space transformer of any of paragraphs B1-B37, wherein the plurality of electrically conductive attachment points includes a plurality of metallic attachment points.

B39. The space transformer of any of paragraphs B1-B38, wherein the plurality of body electrical conductors includes a plurality of metallic body electrical conductors.

B40. The space transformer of any of paragraphs B1-B39, wherein at least a portion of at least a first subset of the plurality of body electrical conductors extends, within the rigid dielectric body, in a direction that is parallel, or at least substantially parallel, to the planar lower surface.

B41. The space transformer of any of paragraphs B1-B40, wherein at least a portion of at least a second subset of the plurality of body electrical conductors extends, within the rigid dielectric body, in direction that is perpendicular, or at least substantially perpendicular, to the planar lower surface.

C1. A planarization layer for a space transformer, the planarization layer comprising:

(i) optionally an interposer including an upper interposer surface, an opposed lower interposer surface, a plurality of upper interposer contact pads on the upper interposer surface, a plurality of lower interposer contact pads on the lower interposer surface, and a plurality of interposer electrical conductors extending between the plurality of upper interposer contact pads and the plurality of lower interposer contact pads;

(ii) a resilient dielectric layer conformally extending across one of (a) a surface and a plurality of contact pads, (b) the lower interposer surface and the plurality of lower interposer contact pads, and (c) a lower surface of a space transformer body of the space transformer and a plurality of space transformer contact pads of the space transformer;

(iii) a planarized rigid dielectric layer including a planarized lower surface and an upper surface that extends across, and is conformal with, the resilient dielectric layer;

(iv) a plurality of holes extending from the planarized lower surface, through the planarized rigid dielectric layer and the resilient dielectric layer, to one of (a) respective ones of the contact pads, (b) respective ones of the plurality of lower interposer contact pads, and (c) respective ones of the plurality of space transformer contact pads; and

(v) an electrically conductive paste extending within each of the plurality of holes from the planarized lower surface to one of (a) the respective ones of the contact pads, (b) the respective ones of the plurality of lower interposer contact pads, and (c) the respective ones of the plurality of space transformer contact pads.

C2. The planarization layer of paragraph C1, wherein the interposer includes a printed circuit board.

C3. The planarization layer of paragraph C2, wherein the printed circuit board includes a polymeric substrate that defines at least one, and optionally both, the upper interposer surface and the opposed lower interposer surface.

C4. The planarization layer of any of paragraphs C1-C2, wherein the interposer includes a silicon substrate that defines at least one, and optionally both, the upper interposer surface and the opposed lower interposer surface.

C5. The planarization layer of paragraph C4, wherein the silicon substrate includes a plurality of through silicon vias, wherein the plurality of through silicon vias defines the plurality of interposer electrical conductors, optionally wherein the plurality of through silicon vias further defines the plurality of upper interposer contact pads, and further optionally wherein the plurality of through silicon vias further defines the plurality of lower interposer contact pads.

C6. The planarization layer of any of paragraphs C1-C5, wherein the interposer includes a ceramic substrate that defines at least one, and optionally both, the upper interposer surface and the opposed lower interposer surface.

C7. The planarization layer of any of paragraphs C1-C6, wherein each of the plurality of upper interposer contact pads is directly opposed to a corresponding one of the plurality of lower interposer contact pads.

C8. The planarization layer of any of paragraphs C1-C7, wherein each of the plurality of interposer electrical conductors extends perpendicular, or at least substantially perpendicular, to the upper interposer surface and to the lower interposer surface.

C9. The planarization layer of any of paragraphs C1-C8, wherein the upper interposer surface is parallel, or at least substantially parallel, to the lower interposer surface.

C10. The planarization layer of any of paragraphs C1-C9, wherein the plurality of upper interposer contact pads projects from the upper interposer surface.

C11. The planarization layer of any of paragraphs C1-C10, wherein the plurality of lower interposer contact pads projects from the lower interposer surface.

C12. The planarization layer of any of paragraphs C1-C11, wherein the upper interposer surface is a planar, or at least substantially planar, upper interposer surface.

C13. The planarization layer of any of paragraphs C1-C12, wherein the lower interposer surface is a planar, or at least substantially planar, lower interposer surface.

C14. The planarization layer of any of paragraphs C1-C13, wherein the resilient dielectric layer includes a resilient dielectric adhesive.

C15. The planarization layer of any of paragraphs C1-C14, wherein a stiffness of the resilient dielectric layer is less than a threshold fraction of a stiffness of the planarized rigid dielectric layer optionally during fabrication of the planarization layer, and further optionally wherein the stiffness of the resilient dielectric layer is comparable to the stiffness of the planarized rigid dielectric layer subsequent to fabrication of the planarization layer.

C16. The planarization layer of paragraph C15, wherein the threshold fraction is less than 80%, less than 70%, less than 60%, less than 50%, less than 40%, less than 30%, less than 20%, or less than 10% of the stiffness of the planarized rigid dielectric layer.

C17. The planarization layer of any of paragraphs C1-C16, wherein the planarized lower surface of the planarized rigid dielectric layer is planar, or at least substantially planar.

C18. The planarization layer of any of paragraphs C1-C17, wherein the planarized lower surface of the rigid dielectric layer deviates from being planar by a threshold height variation, wherein the threshold height variation is at most 40 micrometers, at most 30 micrometers, at most 20 micrometers, at most 15 micrometers, at most 10 micrometers, at most 8 micrometers, at most 6 micrometers, or at most 4 micrometers.

C19. The planarization layer of any of paragraphs C1-C18, wherein the upper surface of the planarized rigid dielectric layer is nonplanar.

C20. The planarization layer of any of paragraphs C1-C19, wherein the electrically conductive paste includes, or is, at least one of an electrically conductive metal paste, an electrically conductive metal alloy paste, an electrically conductive copper paste, and an electrically conductive copper alloy paste.

C21. A planarized space transforming structure, comprising:

a/the space transformer including an upper space transformer surface, an opposed planar lower space transformer surface, and a/the plurality of space transformer contact pads on the planar lower space transformer surface; and

the planarization layer of any of paragraphs C1-C20, wherein at least one of:

(i) the interposer is operatively attached to the lower space transformer surface such that each of the plurality of upper interposer contact pads is in electrical communication with a corresponding one of the plurality of space transformer contact pads; and

(ii) the resilient dielectric layer is operatively attached to the planar lower space transformer surface.

C22. The planarized space transforming structure of paragraph C21, wherein the space transformer includes, and optionally is, the space transformer of any of paragraphs A1-B41.

C23. The planarized space transforming structure of any of paragraphs C21-C22, wherein the plurality of space transformer contact pads projects from the planar lower space transformer surface.

C24. The planarized space transforming structure of any of paragraphs C21-C23, wherein the plurality of space transformer contact pads is a plurality of lower space transformer contact pads, and further wherein the space transformer includes a plurality of upper space transformer contact pads on the upper space transformer surface.

C25. The planarized space transforming structure of paragraph C24, wherein an average pitch, or spacing, of the plurality of lower space transformer contact pads is less than a threshold fraction of an average pitch, or spacing, of the plurality of upper space transformer contact pads.

C26. The planarized space transforming structure of any of paragraphs C24-C25, wherein an average distance between each of the plurality of lower space transformer contact pads and a closest other of the plurality of lower space transformer contact pads is less than a threshold fraction of an average distance between each of the plurality of upper space transformer contact pads and a closest other of the plurality of upper space transformer contact pads.

C27. The planarized space transforming structure of any of paragraphs C25-C26, wherein the threshold fraction is at least one of:

(i) at least 1%, at least 5%, at least 10%, at least 20%, or at least 25% of the average pitch, or spacing, of the plurality of upper space transformer contact pads; and

(ii) at most 400%, at most 300%, at most 200%, at most 100%, at most 50%, at most 40%, at most 30%, at most 20%, at most 10%, at most 5%, at most 1%, or at most 0.1% of the average pitch, or spacing, of the plurality of upper space transformer contact pads.

C28. The planarized space transforming structure of any of paragraphs C24-C27, wherein the space transformer further includes a plurality of space transformer electrical conductors extending between the plurality of upper space transformer contact pads and the plurality of lower space transformer contact pads.

C29. The planarized space transforming structure of any of paragraphs C21-C28, wherein the planarization layer further includes an adhesive layer extending across the planarized lower surface of the planarized rigid dielectric layer.

C30. The planarized space transforming structure of paragraph C29, wherein the plurality of holes extends through the adhesive layer.

C31. The planarized space transforming structure of paragraph C30, wherein the adhesive layer includes a lower adhesive layer surface and an opposed upper adhesive layer surface, which is in contact with the planarized lower surface of the planarized rigid dielectric layer, wherein the electrically conductive paste extends, within each of the plurality of holes, from the lower adhesive layer surface to the respective ones of the plurality of lower interposer contact pads.

C32. The planarized space transforming structure of any of paragraphs C30-C31, wherein the electrically conductive paste further projects from each of the plurality of holes and past the lower adhesive layer surface.

C33. The planarized space transforming structure of any of paragraphs C29-C32, wherein the adhesive layer is at least one of a dielectric adhesive layer, an electrically insulating adhesive layer, and a polymeric adhesive layer.

C34. The planarized space transforming structure of any of paragraphs C29-C33, wherein the planarized space transforming structure further includes a membrane structure including a dielectric membrane that defines an upper membrane surface and an opposed lower membrane surface, wherein the membrane structure further includes a plurality of membrane conductors, and further wherein the membrane structure is adhered to the planarized lower surface of the planarized rigid dielectric layer by the adhesive layer.

C35. The planarized space transforming structure of paragraph C34, wherein the electrically conductive paste defines a plurality of planarization layer conductors that extends within the plurality of holes, and further wherein each of the plurality of membrane conductors electrically contacts a corresponding one of the plurality of planarization layer conductors.

C36. The planarized space transforming structure of paragraph C35, wherein the electrically conductive paste is, includes, or is instead, at least one of a sintered electrically conductive paste, a sintered metal, and a sintered metal alloy.

D1. A method of fabricating a space transformer assembly, the method comprising:

providing a first rigid space transformer layer;

providing a second rigid space transformer layer; and

assembling the first rigid space transformer layer and the second rigid space transformer layer to define the space transformer assembly, wherein the assembling includes operatively attaching the first rigid space transformer layer to the second rigid space transformer layer via an attachment layer that extends between the first rigid space transformer layer and the second rigid space transformer layer.

D2. The method of paragraph D1, wherein the providing the first rigid space transformer layer includes at least one of providing a pre-fabricated first rigid space transformer layer and fabricating the first rigid space transformer layer.

D3. The method of any of paragraphs D1-D2, wherein the providing the second rigid space transformer layer includes at least one of providing a pre-fabricated second rigid space transformer layer and fabricating the second rigid space transformer layer.

D4. The method of any of paragraphs D1-D3, wherein the providing the first rigid space transformer layer and the providing the second rigid space transformer layer are performed at least partially concurrently, and optionally simultaneously.

D5. The method of any of paragraphs D1-D4, wherein the providing the first rigid space transformer layer includes providing a first finished, manufactured product.

D6. The method of any of paragraphs D1-D5, wherein the providing the second rigid space transformer layer includes providing a second finished, manufactured product.

D7. The method of any of paragraphs D1-D6, wherein the operatively attaching includes adhering the first rigid space transformer layer to the second rigid space transformer layer.

D8. The method of any of paragraphs D1-D7, wherein the first rigid space transformer layer includes a plurality of first contact pads, wherein the second rigid space transformer layer includes a plurality of second contact pads, and further wherein the operatively attaching includes:

(i) applying an electrically conductive paste such that the electrically conductive paste extends between each of the plurality of first contact pads and a corresponding one of the plurality of second contact pads; and

(ii) sintering the electrically conductive paste to define a plurality of discrete attachment layer conductors, wherein each of the plurality of discrete attachment layer conductors extends between a respective one of the plurality of first contact pads and the corresponding one of the plurality of second contact pads.

D9. The method of any of paragraphs D1-D8, wherein the operatively attaching includes positioning the attachment layer between the first rigid space transformer layer and the second rigid space transformer layer.

D10. The method of any of paragraphs D1-D9, wherein the method further includes selecting the first rigid space transformer layer and the second rigid space transformer layer from a selection of rigid space transformer layers.

D11. The method of paragraph D10, wherein the selecting includes selecting based, at least in part, upon a selection criteria.

D12. The method of paragraph D11, wherein a selection criteria for the first rigid space transformer layer is different from a selection criteria for the second rigid space transformer layer.

D13. The method of any of paragraphs D10-D12, wherein the selecting includes selecting one of the first rigid space transformer layer and the second rigid space transformer layer based upon power delivery criteria and selecting the other of the first rigid space transformer layer and the second rigid space transformer layer based upon data signal delivery criteria.

D14. The method of any of paragraphs D1-D13, wherein the method includes:

providing a plurality of rigid space transformer layers; and

assembling the plurality of rigid space transformer layers by:

(i) positioning a respective attachment layer between each of the plurality of rigid space transformer layers and at least one adjacent rigid space transformer layer of the plurality of rigid space transformer layers; and

(ii) operatively attaching each of the plurality of rigid space transformer layers to the at least one adjacent rigid space transformer layer via the respective attachment layer.

D15. The method of paragraph D14, wherein the plurality of rigid space transformer layers includes at least one of:

(i) at least 3, at least 4, at least 5, at least 6, at least 8, at least 10, at least 12, at least 14, at least 16, at least 18, or at least 20 rigid space transformer layers; and

(ii) at most 100, at most 90, at most 80, at most 70, at most 60, at most 50, at most 40, at most 30, at most 20, or at most 10 rigid space transformer layers.

D16. The method of any of paragraphs D1-D15, wherein, prior to the assembling, the method further includes testing the operation of at least one, and optionally both, of the first rigid space transformer layer and the second rigid space transformer layer.

D17. The method of any of paragraphs D1-D16, wherein the space transformer assembly includes the space transformer assembly of any of paragraphs A1-A57.

D18. The method of any of paragraphs D1-D17, wherein the space transformer assembly includes any suitable structure and/or component of any of the space transformer assemblies of any of paragraphs A1-A57.

E1. A method of planarizing a surface of an electronic device, the method comprising:

optionally operatively attaching an interposer to the space transformer such that a plurality of space transformer contact pads of the space transformer is operatively attached to, and in electrical communication with, a first plurality of interposer contact pads present on a first surface of the interposer, wherein the interposer further includes a second plurality of interposer contact pads on a second surface of the interposer that is opposed to the first surface of the interposer;

applying a resilient dielectric layer to the electronic device, optionally wherein at least one of:

(i) the applying includes applying the resilient dielectric layer to the interposer such that the resilient dielectric layer extends conformally across the second surface of the interposer and the second plurality of interposer contact pads; and

(ii) the applying includes applying the resilient dielectric layer to a/the space transformer such that the resilient dielectric layer extends conformally across at least a portion of a surface of the space transformer and a/the plurality of space transformer contact pads;

applying a rigid dielectric layer to the resilient dielectric layer such that the resilient dielectric layer extends between the electronic device and the rigid dielectric layer;

planarizing an exposed surface of the rigid dielectric layer to generate a planarized surface of the rigid dielectric layer;

applying an adhesive layer to the planarized surface of the rigid dielectric layer;

applying a masking layer to the adhesive layer such that the adhesive layer extends between the planarized surface of the rigid dielectric layer and the masking layer;

forming a plurality of holes, wherein each of the plurality of holes extends from an exposed surface of the masking layer, through the masking layer, through the adhesive layer, through the rigid dielectric layer, through the resilient dielectric layer, and into contact with at least one of:

(i) the electronic device;

(ii) a corresponding one of the plurality of interposer contact pads; and

(iii) a corresponding one of the plurality of space transformer contact pads; and

applying an electrically conductive paste to the plurality of holes such that the electrically conductive paste defines a plurality of discrete electrical conductors, wherein each of the plurality of discrete electrical conductors extends, within a corresponding hole, from the exposed surface of the masking layer to at least one of:

(i) the electronic device;

(ii) the corresponding one of the plurality of interposer contact pads; and

(iii) the corresponding one of the plurality of space transformer contact pads.

E2. The method of paragraph E1, wherein, subsequent to the applying the electrically conductive paste, the method further includes separating the masking layer from the adhesive layer, wherein, subsequent to the separating, each of the plurality of discrete electrical conductors projects from an exposed surface of the adhesive layer.

E3. The method of paragraph E2, wherein, subsequent to the separating the masking layer from the adhesive layer, the method further includes positioning a membrane structure on the exposed surface of the adhesive layer, wherein the membrane structure includes a dielectric membrane that defines an upper membrane surface and an opposed lower membrane surface, wherein the membrane structure further includes a plurality of membrane conductors, and further wherein the positioning the membrane structure includes positioning such that each of the plurality of discrete electrical conductors electrically contacts a corresponding one of the plurality of membrane conductors.

E4. The method of paragraph E3, wherein, subsequent to the positioning the membrane structure, the method further includes sintering the electrically conductive paste to solidify the electrically conductive paste and generate a plurality of solidified discrete electrical conductors such that the plurality of solidified discrete electrical conductors operatively attaches the membrane structure to the interposer and electrically interconnects the membrane structure and the interposer.

E5. The method of any of paragraphs E3-E4, wherein the positioning the membrane structure further includes adhering the membrane structure to the planarized surface of the rigid dielectric layer via the adhesive layer.

E6. The method of any of paragraphs E1-E5, wherein the space transformer includes the space transformer of any of paragraphs C21-C36.

E7. The method of any of paragraphs E1-E6, wherein the space transformer includes any suitable structure and/or component of any of the planarization layers of any of paragraphs C1-C20 or any of the space transformers of any of paragraphs C21-C36.

### INDUSTRIAL APPLICABILITY

The space transformers, space transformer assemblies, planarization layers for space transformers, and methods disclosed herein are applicable to the semiconductor manufacturing and test industries.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A space transformer assembly, comprising:
a first rigid space transformer layer including:
(i) a planar first layer upper surface;
(ii) a planar first layer lower surface that is opposed to the first layer upper surface;
(iii) a plurality of first upper contact pads on the first layer upper surface;
(iv) a plurality of first lower contact pads on the first layer lower surface; and
(v) a plurality of first electrical conductors oriented to conduct a plurality of electric currents between the plurality of first upper contact pads and the plurality of first lower contact pads;
a second rigid space transformer layer including:
(i) a planar second layer upper surface that faces toward the first layer lower surface;
(ii) a planar second layer lower surface that is opposed to the second layer upper surface;
(iii) a plurality of second layer upper contact pads on the second layer upper surface;
(iv) a plurality of second layer lower contact pads on the second layer lower surface; and
(v) a plurality of second electrical conductors oriented to conduct the plurality of electric currents between the plurality of second layer upper contact pads and the plurality of second layer lower contact pads; and
an attachment layer that extends between the first rigid space transformer layer and the second rigid space transformer layer, operatively attaches the first rigid space transformer layer to the second rigid space transformer layer, and electrically interconnects each of the plurality of first lower contact pads to a corresponding one of the plurality of second layer upper contact pads.

2. The assembly of claim 1, wherein the plurality of first electrical conductors of the first rigid space transformer layer includes at least one of:
(i) at least one first electrically conductive via that extends perpendicular, or at least substantially perpendicular, to the first layer upper surface and between a via contact pad of the plurality of first upper contact pads and a corresponding via contact pad of the plurality of first lower contact pads; and
(ii) at least one first electrically conductive trace that extends parallel, or at least substantially parallel, to the first layer upper surface and between a trace contact pad of the plurality of first upper contact pads and a corresponding trace contact pad of the plurality of first lower contact pads.

3. The assembly of claim 1, wherein the plurality of second electrical conductors of the second rigid space transformer layer includes at least one of:
(i) at least one second electrically conductive via that extends perpendicular, or at least substantially perpendicular, to the second layer upper surface and between a via contact pad of the plurality of second layer upper contact pads and a corresponding via contact pad of the plurality of second lower contact pads; and
(ii) at least one second electrically conductive trace that extends parallel, or at least substantially parallel, to the second layer upper surface and between a trace contact pad of the plurality of second layer upper contact pads and a corresponding trace contact pad of the plurality of second layer lower contact pads.

4. The assembly of claim 1, wherein at least one of the first rigid space transformer layer and the second rigid space transformer layer is configured to convey a direct current power signal therethrough, and further wherein the other of the first rigid space transformer layer and the second rigid space transformer layer is configured to convey an alternating current data signal therethrough.

5. The assembly of claim 1, wherein the space transformer assembly further includes at least one of:
(i) at least one intermediate rigid space transformer layer that extends between the first rigid space transformer layer and the second rigid space transformer layer;
(ii) at least one upper rigid space transformer layer that is operatively attached to the first planar layer upper surface; and
(iii) at least one lower rigid space transformer layer that is operatively attached to the planar second layer lower surface.

6. The assembly of claim 1, wherein the first rigid space transformer layer includes a modular capacitor bank that includes a plurality of capacitors.

7. The assembly of claim 1, wherein the space transformer assembly further includes a flexible membrane layer that is operatively attached to the second layer lower surface of the second rigid space transformer layer.

8. The assembly of claim 7, wherein the membrane layer includes:
(i) a membrane upper surface that faces toward the second layer lower surface;
(ii) a membrane lower surface that is opposed to the membrane upper surface;
(iii) a plurality of membrane upper contact pads on the membrane upper surface;
(iv) a plurality of membrane lower contact pads on the membrane lower surface; and
(v) a plurality of membrane electrical conductors oriented to conduct a plurality of electric currents between the plurality of membrane upper contact pads and the plurality of membrane lower contact pads;
wherein a relative orientation of the plurality of membrane upper contact pads corresponds to a relative orientation of the plurality of second layer lower contact pads, and further wherein a relative orientation of the plurality of membrane lower contact pads is selected to adapt the plurality of second layer lower contact pads to a desired relative orientation.

9. The assembly of claim 1, wherein at least one of the first rigid space transformer layer and the second rigid space transformer layer includes at least one of a printed circuit board and a high density interconnect layer.

10. The assembly of claim 1, wherein the attachment layer is an electrically conductive attachment layer.

11. The assembly of claim 1, wherein the attachment layer includes a plurality of discrete electrical conductors extending between each of the plurality of first lower contact pads and the corresponding one of the plurality of second layer upper contact pads.

12. The assembly of claim 1, wherein the attachment layer is selectively located to extend only between each of the plurality of first lower contact pads and corresponding ones of the plurality of second layer upper contact pads.

13. The assembly of claim 1, wherein the assembly further includes at least one air gap that extends between the first rigid space transformer layer and the second rigid space transformer layer.

14. A method of fabricating a space transformer assembly, the method comprising:
providing a first rigid space transformer layer;
providing a second rigid space transformer layer; and
assembling the first rigid space transformer layer and the second rigid space transformer layer to define the space transformer assembly, wherein the assembling includes operatively attaching the first rigid space transformer layer to the second rigid space transformer layer via an attachment layer that extends between the first rigid space transformer layer and the second rigid space transformer layer.

15. The method of claim 14, wherein the providing the first rigid space transformer layer includes at least one of providing a pre-fabricated first rigid space transformer layer and fabricating the first rigid space transformer layer, and further wherein the providing the second rigid space transformer layer includes at least one of providing a pre-fabricated second rigid space transformer layer and fabricating the second rigid space transformer layer.

16. The method of claim 14, wherein the providing the first rigid space transformer layer and the providing the second rigid space transformer layer are performed at least partially concurrently.

17. The method of claim 14, wherein the providing the first rigid space transformer layer includes providing a first finished, manufactured product, and further wherein the providing the second rigid space transformer layer includes providing a second finished, manufactured product.

18. The method of claim 14, wherein the operatively attaching includes adhering the first rigid space transformer layer to the second rigid space transformer layer.

19. The method of claim 14, wherein the first rigid space transformer layer includes a plurality of first contact pads, wherein the second rigid space transformer layer includes a plurality of second contact pads, and further wherein the operatively attaching includes:
(i) applying an electrically conductive paste such that the electrically conductive paste extends between each of the plurality of first contact pads and a corresponding one of the plurality of second contact pads; and
(ii) sintering the electrically conductive paste to define a plurality of discrete attachment layer conductors, wherein each of the plurality of discrete attachment layer conductors extends between a respective one of the plurality of first contact pads and the corresponding one of the plurality of second contact pads.

20. The method of claim 14, wherein the method further includes selecting the first rigid space transformer layer and the second rigid space transformer layer from a selection of rigid space transformer layers.

21. The method of claim 20, wherein the selecting includes selecting based, at least in part, upon a selection criteria, wherein a selection criteria for the first rigid space transformer layer is different from a selection criteria for the second rigid space transformer layer.

22. The method of claim 20, wherein the selecting includes selecting one of the first rigid space transformer layer and the second rigid space transformer layer based upon power delivery criteria and selecting the other of the first rigid space transformer layer and the second rigid space transformer layer based upon data signal delivery criteria.

23. The method of claim 14, wherein, prior to the assembling, the method further includes testing the operation of both the first rigid space transformer layer and the second rigid space transformer layer.

24. A space transformer, comprising:
a space transformer body, including:
(i) a rigid dielectric body including a upper surface and an opposed planar lower surface;
(ii) a plurality of electrically conductive contact pads on the planar lower surface;
(iii) a plurality of electrically conductive attachment points supported by the rigid dielectric body; and
(iv) a plurality of body electrical conductors supported by the rigid dielectric body, wherein each of the plurality of body electrical conductors extends between a selected one of the plurality of electrically conductive attachment points and a corresponding one of the plurality of electrically conductive contact pads; and
a flex cable assembly including a plurality of ribbon electrical conductors defining a plurality of cable ribbons, wherein each of the plurality of cable ribbons includes a corresponding subset of the plurality of ribbon electrical conductors, wherein the plurality of cable ribbons defines a layered stack of cable ribbons, and further wherein each of the plurality of ribbon electrical conductors includes a body-proximal conductor end, which is operatively attached to a corresponding one of the plurality of electrically conductive attachment points, and a body-distal conductor end.

25. A planarization layer for a space transformer, the planarization layer comprising:
(i) a resilient dielectric layer conformally extending across a surface and a plurality of contact pads;
(ii) a planarized rigid dielectric layer including a planarized lower surface and an upper surface that extends across, and is conformal with, the resilient dielectric layer;
(iii) a plurality of holes extending from the planarized lower surface, through the planarized rigid dielectric layer and the resilient dielectric layer, to respective ones of the plurality of contact pads; and
(iv) an electrically conductive paste extending within each of the plurality of holes from the planarized lower surface to the respective ones of the plurality of contact pads.

26. A method of planarizing an electronic device, the method comprising:
applying a resilient dielectric layer to the electronic device;
applying a rigid dielectric layer to the resilient dielectric layer such that the resilient dielectric layer extends between the electronic device and the rigid dielectric layer;
planarizing an exposed surface of the rigid dielectric layer to generate a planarized surface of the rigid dielectric layer;
applying an adhesive layer to the planarized surface of the rigid dielectric layer;
applying a masking layer to the adhesive layer such that the adhesive layer extends between the planarized surface of the rigid dielectric layer and the masking layer;
forming a plurality of holes, wherein each of the plurality of holes extends from an exposed surface of the masking layer, through the masking layer, through the adhesive layer, through the rigid dielectric layer, through the resilient dielectric layer, and into contact with the electronic device; and
applying an electrically conductive paste to the plurality of holes such that the electrically conductive paste defines a plurality of discrete electrical conductors, wherein each of the plurality of discrete electrical conductors extends, within a corresponding hole, from the exposed surface of the masking layer to the electronic device.
